(19) United States
(12) Patent Application Publication
(10) Pub. No.: US 2023/0130993 A1
(43) Pub. Date: Apr. 27, 2023

(54) Systems and Methods for Spatially-Stepped Imaging

(71) Applicant: AEYE, Inc., Dublin, CA (US)

(72) Inventors: Hod Finkelstein, Albany, CA (US); Vadim Shofman, Dublin, CA (US); Allan Steinhardt, Dublin, CA (US)

(21) Appl. No.: 17/970,761

(22) Filed: Oct. 21, 2022

Related U.S. Application Data
(63) Continuation of application No. PCT/US22/47262, filed on Oct. 20, 2022.
(60) Provisional application No. 63/271,141, filed on Oct. 23, 2021.
(60) Provisional application No. 63/281,582, filed on Nov. 19, 2021.
(60) Provisional application No. 63/325,231, filed on Mar. 30, 2022.
(60) Provisional application No. 63/271,141, filed on Oct. 23, 2021.
(60) Provisional application No. 63/281,582, filed on Nov. 19, 2021.
(60) Provisional application No. 63/325,231, filed on Mar. 30, 2022.

(51) Int. Cl. G01S 7/481; G01S 17/89

(52) U.S. Cl. CPC G01S 7/4817; G01S 7/4816; G01S 17/89

(57) ABSTRACT

Techniques for imaging such as lidar imaging are described where a plurality of light steering optical elements are moved (such as rotated) to align different light steering optical elements with (1) an optical path of emitted optical signals at different times and/or (2) an optical path of optical returns from the optical signals to an optical sensor at different times. Each light steering optical element corresponds to a zone within the field of view and provides (1) steering of the emitted optical signals incident thereon into its corresponding zone and/or (2) steering of the optical returns from its corresponding zone to the optical sensor so that movement of the light steering optical elements causes the imaging system to step through the zones on a zone-by-zone basis according to which of the light steering optical elements becomes aligned with the optical path of the emitted optical signals and/or the optical path of the optical returns over time.

### CROSS-REFERENCE AND PRIORITY CLAIM TO RELATED PATENT APPLICATIONS

This patent application is a continuation of PCT patent application PCT/US22/47262 (designating the US), filed Oct. 20, 2022, and entitled “Systems and Methods for Spatially-Stepped Imaging”, which claims priority to (1) U.S. provisional patent application Ser. No. 63/271,141, filed Oct. 23, 2021, and entitled “Spatially-Stepped Flash Lidar System”, (2) U.S. provisional patent application Ser. No. 63/281,582, filed Nov. 19, 2021, and entitled “System and Method for Spatially-Stepped Flash Lidar”, and (3) U.S. provisional patent application Ser. No. 63/325,231, filed Mar. 30, 2022, and entitled “Systems and Methods for Spatially-Stepped Flash Lidar Using Diffractive Optical Elements for Light Steering”, the entire disclosures of each of which are incorporated herein by reference.

This patent application also claims priority to (1) U.S. provisional patent application Ser. No. 63/271,141, filed Oct. 23, 2021, and entitled “Spatially-Stepped Flash Lidar System”, (2) U.S. provisional patent application Ser. No. 63/281,582, filed Nov. 19, 2021, and entitled “System and Method for Spatially-Stepped Flash Lidar”, and (3) U.S. provisional patent application Ser. No. 63/325,231, filed Mar. 30, 2022, and entitled “Systems and Methods for Spatially-Stepped Flash Lidar Using Diffractive Optical Elements for Light Steering”, the entire disclosures of each of which are incorporated herein by reference.

### INTRODUCTION

There are needs in the art for improved imaging systems and methods. For example, there are needs in the art for improved lidar imaging techniques, such as flash lidar systems and methods. As used herein, “lidar”, which can also be referred to as “ladar”, refers to and encompasses any of light detection and ranging, laser radar, and laser detection and ranging.

Flash lidar provides a tool for three-dimensional imaging that can be capable of imaging over large fields of view (FOVs), such as 160 degrees (horizontal) by 120 degrees (vertical). Conventional flash lidar systems typically suffer from limitations that require large detector arrays (e.g., focal plane arrays (FPAs)), large lenses, and/or large spectral filters. Furthermore, conventional flash lidar systems also suffer from the need for large peak power. For example, conventional flash lidar systems typically need to employ detector arrays on the order of 1200×1600 pixels to image a 120 degree by 160 degree FOV with a 0.1×0.1 degree resolution. Not only is such a large detector array expensive, but the use of a large detector array also translates into a need for a large spectral filter and lens, which further contributes to cost.

The principle of conservation of etendue typically operates to constrain the design flexibility with respect to flash lidar systems. Lidar systems typically require a large lens in order to collect more light given that lidar systems typically employ a laser source with the lowest feasible power. It is because of this requirement for a large collection aperture and a wide FOV with a conventional wide FOV lidar system that the etendue of the wide FOV lidar system becomes large. Consequently, in order to preserve etendue, the filter aperture area (especially for narrowband filters which have a narrow angular acceptance) may become very large. Alternately, the etendue at the detector plane may be the limiting one for the system. If the numerical aperture of the imaging system is high (which means a low f #) and the area of the focal plane is large (because there are many pixels in the array and their pitch is not small, e.g., they are 10 μm or 20 μm or 30 μm in pitch), then the detector's etendue becomes the critical one that drives the filter area. FIG. 7 and the generalized expression below illustrates how conservation of etendue operates to fix most of the design parameters of a flash lidar system, where Aₗ, A_{f}, and A_{FPA} represent the areas of the collection lens (see upper lens in FIG. 7, filter, and focal plane array respectively); and where Ω₁, Ω₂, and Ω₃ represent the solid angle imaged by the collection lens, the solid angle required by the filter to achieve passband, and the solid angle subtended by the focal plane array respectively.

AₗΩ₁=A_{f}Ω₂=A_{FPA}Ω₃

The first term of this expression (AₗΩ₁) is typically fixed by system power budget and FOV. The second term of this expression (A_{f}Ω₂) is typically fixed by filter technology and the passband. The third term of this expression (A_{FPA}Ω₃) is typically fixed by lens cost and manufacturability. With these constraints, conservation of etendue typically means that designers are forced into deploying expensive system components to achieve desired imaging capabilities.

As a solution to this problem in the art, the inventor discloses a flash lidar technique where the lidar system spatially steps flash emissions and acquisitions across a FOV to achieve zonal flash illuminations and acquisitions within the FOV, and where these zonal acquisitions constitute subframes that can be post-processed to assemble a wide FOV lidar frame. In doing so, the need for large lenses, large spectral filters, and large detector arrays is reduced, providing significant cost savings for the flash lidar system while still retaining effective operational capabilities. In other words, the spatially-stepped zonal emissions and acquisitions operate to reduce the FOV per shot relative to conventional flash lidar systems, and reducing the FOV per shot reduces the light throughput of the system, which in turn enables for example embodiments a reduction in filter area and a reduction in FPA area without significantly reducing collection efficiency or optics complexity.

With this approach, a practitioner can design an imaging system which can provide a wide field of view with reasonable resolution (e.g. 30 frames per second (fps)), while maintaining a low cost, low power consumption, and reasonable size (especially in depth, for side integration). Furthermore, this approach can also provide reduced susceptibility to motion artifacts which may arise due to fast angular velocity of objects at close range. Further still, this approach can have reduced susceptibility to shocks and vibrations. Thus, example embodiments described herein can serve as imaging systems that deliver high quality data at low cost. As an example, lidar systems using the techniques described herein can serve as a short-range imaging system that provides cocoon 3D imaging around a vehicle such as a car.

Accordingly, as an example embodiment, disclosed herein is a lidar system comprising (1) an optical emitter that emits optical signals into a field of view, wherein the field of view comprises a plurality of zones, (2) an optical sensor that senses optical returns of a plurality of the emitted optical signals from the field of view, and (3) a plurality of light steering optical elements that are movable to align different light steering optical elements with (1) an optical path of the of the emitted optical signals at different times and/or (2) an optical path of the optical returns to the optical sensor at different times. Each light steering optical element corresponds to a zone within the field of view and provides (1) steering of the emitted optical signals incident thereon into its corresponding zone and/or (2) steering of the optical returns from its corresponding zone to the optical sensor so that movement of the light steering optical elements causes the lidar system to step through the zones on a zone-by-zone basis according to which of the light steering optical elements becomes aligned with the optical path of the emitted optical signals and/or the optical path of the optical returns over time. The inventors also disclose a corresponding method for operating a lidar system.

As another example embodiment disclosed herein is a flash lidar system for illuminating a field of view over time, the field of view comprising a plurality of zones, the system comprising (1) a light source, (2) a movable carrier, and (3) a circuit. The light source can be an optical emitter that emits optical signals. The movable carrier can comprise a plurality of different light steering optical elements that align with an optical path of the emitted optical signals at different times in response to movement of the carrier, wherein each light steering optical element corresponds to one of the zones and provides steering of the emitted optical signals incident thereon into its corresponding zone. The circuit can drive movement of the carrier to align the different light steering optical elements with the optical path of the emitted optical signals over time to flash illuminate the field of view with the emitted optical signals on a zone-by-zone basis.

Furthermore, the system may also include an optical sensor that senses optical returns of the emitted optical signals, and the different light steering optical elements can also align with an optical path of the returns to the optical sensor at different times in response to the movement of the carrier and provide steering of the returns incident thereon from their corresponding zones to the optical sensor so that the optical sensor senses the returns on the zone-by-zone basis. The zone-specific sensed returns can be used to form lidar sub-frames, and these lidar sub-frames can be aggregated to form a full FOV lidar frame. With such a system, each zone's corresponding light steering optical element may include (1) an emitter light steering optical element that steers emitted optical signals incident thereon into its corresponding zone when in alignment with the optical path of the optical signals during movement of the carrier and (2) a paired receiver light steering optical element that steers returns incident thereon from its corresponding zone to the optical sensor when in alignment with the optical path of the returns to the optical sensor during movement of the carrier. The zone-specific paired emitter and receiver light steering optical elements can provide the same steering to/from the field of view. In an example embodiment for spatially-stepped flash (SSF) imaging, the system can spatially step across the zones and acquire time correlated single photon counting (TCSPC) histograms for each zone.

Also disclosed herein is a lidar method for flash illuminating a field of view over time, the field of view comprising a plurality of zones, the method comprising (1) emitting optical signals for transmission into the field of view and (2) moving a plurality of different light steering optical elements into alignment with an optical path of the emitted optical signals at different times, wherein each light steering optical element corresponds to one of the zones and provides steering of the emitted optical signals incident thereon into its corresponding zone to flash illuminate the field of view with the emitted optical signals on a zone-by-zone basis.

This method may also include steps of (1) steering optical returns of the emitted optical signals onto a sensor via the moving light steering optical elements, wherein each moving light steering optical element is synchronously aligned with the sensor when in alignment with the optical path of the emitted optical signals during the moving and (2) sensing the optical returns on the zone-by-zone basis based on the steered optical returns that are incident on the sensor.

As examples, the movement discussed above for the lidar system and method can take the form of rotation, and the carrier can take the form of a rotator, in which case the circuit drives rotation of the rotator to (1) align the different light steering optical elements with the optical path of the emitted optical signals over time to flash illuminate the field of view with the emitted optical signals on the zone-by-zone basis and (2) align with the optical path of the returns to the optical sensor at different times in response to the rotation of the rotator and provide steering of the returns incident thereon from their corresponding zones to the optical sensor so that the optical sensor senses the returns on the zone-by-zone basis. The rotation can be continuous rotation, but the zonal changes would still take the form of discrete steps across the FOV because the zone changes would occur in a step-wise fashion as new light steering optical elements become aligned with the optical paths of the emitted optical signals and returns. For example, each zone can correspond to multiple angular positions of a rotator or carrier on which the light steering optical elements are mounted. In this way, the rotating light steering optical elements can serve as an optical translator that translates continuous motion of the light steering optical elements into discrete changes in the zones of illumination and acquisition over time.

This ability to change zones of illumination/acquisition in discrete steps even if the carrier is continuously moving (e.g., rotating) enables the use of relatively longer dwell times per zone for a given amount of movement than would be possible with prior art approaches to beam steering in the art. For example, Risley prisms are continuously rotated to produce a beam that is continuously steered in space in synchronicity with a continuous rotation of the Risley prisms (in which case any rotation of the Risley prism would produce a corresponding change in light steering). By contrast, with example embodiments that employ a continuous movement (such as rotation) of the carrier, the same zone will remain illuminated by the system even while the carrier continues to move for the time duration that a given light steering optical element is aligned with the optical path of the emitted optical signals. The zone of illumination will not change (or will remain static) until the next light steering optical element becomes aligned with the optical path of the emitted optical signals. Similarly, the sensor will acquire returns from the same zone even while the carrier continues to move for the time duration that a given light steering optical element is aligned with the optical path of the returns to the sensor. The zone of acquisition will not change until the next light steering optical element becomes aligned with the optical path of the returns to the sensor. By supporting such discrete changes in zonal illumination/acquisition even while the carrier is continuously moving, the system has an ability to support longer dwell times per zone and thus deliver sufficient optical energy (e.g., a sufficiently large number of pulses) into each zone and/or provide sufficiently long acquisition of return signals from targets in each zone, without needing to stop and settle at each imaging position.

However, it should be understood that with other example embodiments, the movement need not be rotation; for example, the movement can be linear movement (such as back and forth movement of the light steering optical elements).

Further still, in example embodiments, the light steering optical elements can take the form of transmissive light steering optical elements.

In other example embodiments, the light steering optical elements can take the form of diffractive optical elements (DOEs). In example embodiments, the DOEs may comprise metasurfaces. Due to their thin and lightweight nature, it is expected that using metasurfaces as the light steering optical elements will be advantageous in terms of system dimensions and cost as well as their ability in example embodiment to steer light to larger angles without incurring total internal reflection.

Further still, in other example embodiments, the light steering optical elements can take the form of reflective light steering optical elements.

Further still, the use of light steering optical elements as described herein to provide spatial stepping through zones of a field of view can also be used with lidar systems that operate using point illumination and/or with non-lidar imaging systems such as active illumination imaging systems (e.g., active illumination cameras).

These and other features and advantages of the invention will be described in greater detail below.

### BRIEF DESCRIPTION OF THE DRAWINGS

FIG. 1A shows an example system architecture for zonal flash illumination in accordance with an example embodiment.

FIG. 1B shows an example of a how a field of view can be subdivided into different zones for step-wise illumination and acquisition by the flash lidar system.

FIG. 1C shows an example rotator architecture for a plurality of zone-specific light steering optical elements.

FIG. 2A shows an example system architecture for zonal flash illumination and zonal flash return acquisitions in accordance with an example embodiment.

FIG. 2B shows an example rotator architecture for a plurality of zone-specific light steering optical elements for use with both zone-specific flash illuminations and acquisitions.

FIG. 3 shows an example plot of the chief ray angle out for the emitted optical signals versus the angle between the collimated source beam and the lower facet of an aligned light steering optical element.

FIG. 4 shows an example of histograms used for photon counting to perform time-correlated return detections.

FIGS. 5A-5D show example 2D cross-sectional geometries for examples of transmissive light steering optical elements that can be used for beam steering in a rotative embodiment of the system.

FIG. 6 shows an example 3D shape for a transmissive light steering optical element whose slope on its upper facet is non-zero in radial and tangential directions.

FIG. 7 shows an example receiver architecture that demonstrates conservation of etendue principles.

FIG. 8 shows an example circuit architecture for a lidar system in an accordance with an example embodiment.

FIG. 9 shows an example multi-junction VCSEL array.

FIG. 10 shows an example where a VCSEL driver can independently control multiple VCSEL dies.

FIGS. 11A and 11B show an example doughnut arrangement for emission light steering optical elements along with a corresponding timing diagram.

FIGS. 12A and 12B show another example doughnut arrangement for emission light steering optical elements along with a corresponding timing diagram.

FIG. 13 shows an example bistatic architecture for carriers of light steering optical elements for transmission and reception.

FIG. 14 shows an example tiered architecture for carriers of light steering optical elements for transmission and reception.

FIG. 15A shows an example concentric architecture for carriers of light steering optical elements for transmission and reception.

FIG. 15B shows an example where the concentric architecture of FIG. 15A is embedded in a vehicle door.

FIG. 16 shows an example monostatic architecture for light steering optical elements shared for transmission and reception.

FIGS. 17A-17C show examples of geometries for transmissive light steering optical elements in two dimensions.

FIGS. 18A-18C show examples of geometries for transmissive light steering optical elements in three dimensions.

FIGS. 19A and 19B show additional examples of geometries for transmissive light steering optical elements in two dimensions.

FIG. 20A shows an example light steering architecture using transmissive light steering optical elements.

FIG. 20B shows an example light steering architecture using diffractive light steering optical elements.

FIG. 20C shows another example light steering architecture using diffractive light steering optical elements, where the diffractive optical elements also provide beam shaping.

FIGS. 20D and 20E show example light steering architectures using transmissive light steering optical elements and diffractive light steering optical elements.

FIGS. 21A and 21B show example light steering architectures using reflective light steering optical elements.

FIG. 22 shows an example receiver barrel architecture.

FIG. 23 shows an example sensor architecture.

FIG. 24 shows an example pulse timing diagram for range disambiguation.

FIGS. 25A, 25B, 26A, and 26B show an example of how a phase delay function can be defined for a metasurface to steer a light beam into an upper zone of a field.

FIGS. 27A, 27B, 28A, and 28B show an example of how a phase delay function can be defined for a metasurface to steer a light beam into a lower zone of a field.

FIGS. 29, 30A, and 30B show examples of how a phase delay function can be defined for a metasurface to steer a light beam into a right zone of a field.

FIGS. 31, 32A, and 32B show examples of how a phase delay function can be defined for a metasurface to steer a light beam into a left zone of a field.

FIGS. 33-37D show examples of how phase delay functions can be defined for metasurfaces to steer a light beam diagonally into the corners of a field (e.g., the upper left, upper right, lower left, and lower right zones).

FIG. 38 shows an example scanning lidar transmitter that can be used with a spatially-stepped lidar system.

FIGS. 39A and 39B show examples of how the example scanning lidar transmitter of FIG. 38 can scan within the zones of the spatially-stepped lidar system.

FIG. 40 shows an example lidar receiver that can be used in coordination with the scanning lidar transmitter of FIG. 38 in a spatially-stepped lidar system.

### DETAILED DESCRIPTION OF EXAMPLE EMBODIMENTS

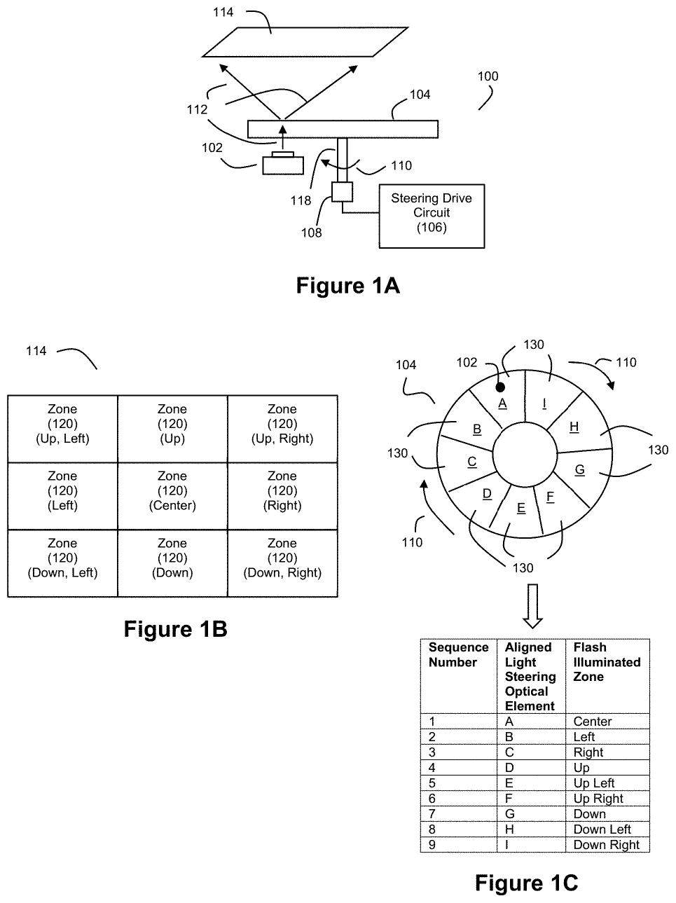

FIG. 1A shows an example flash lidar system 100 in accordance with an example embodiment. The lidar system 100 comprises a light source 102 such as an optical emitter that emits optical signals 112 for transmission into a field of illumination (FOI) 114, a movable carrier 104 that provides steering of the optical signals 112 within the FOI 114, and a steering drive circuit 106 that drives movement of the carrier 104 via an actuator 108 (e.g., motor) and spindle 118 or the like. In the example of FIG. 1A, the movement of carrier 104 is rotation, and the steering drive circuit 106 can be configured to drive the carrier 104 to exhibit a continuous rotation. In the example of FIG. 1A, it can be seen that the axis for the optical path of propagation for the emitted optical signals 112 from the light source 102 to the carrier 104 is perpendicular to the plane of rotation for carrier 104. Likewise, this axis for the optical path of the emitted optical signals 112 from the light source 102 to the carrier 104 is parallel to the axis of rotation for the carrier 104. Moreover, this relationship between (1) the axis for the optical path of emitted optical signals 112 from the light source 102 to the carrier 104 and (2) the plane of rotation for carrier 104 remains fixed during operation of the system 100.

Operation of the system 100 (whereby the light source 102 emits optical signals 112 while the carrier 104 rotates) produces flash illuminations that step across different portions of the FOI 114 over time in response to the rotation of the carrier 104, whereby rotation of the carrier 104 causes discrete changes in the steering of the optical signals 112 over time. These discrete changes in the zones of illumination can be referenced as illumination on a zone-by-zone basis in response to the movement of the carrier 104. FIG. 1B shows an example of how the FOI 114 can be subdivided into smaller portions, where these portions of the FOI 114 can be referred to as zones 120. FIG. 1B shows an example where the FOI 114 is divided into 9 zones 120. In this example, the 9 zones 120 can correspond to (1) an upper left zone 120 (labeled up, left in FIG. 1B), (2) an upper zone 120 (labeled up in FIG. 1B), (3) an upper right zone 120 (labeled up, right in FIG. 1B), (4) a left zone 120 (labeled left in FIG. 1B), (5) a central zone 120 (labeled center in FIG. 1B), (6) a right zone 120 (labeled right in FIG. 1B), (7) a lower left zone 120 (labeled down, left in FIG. 1B), (8) a lower zone 120 (labeled down in FIG. 1B), and (9) a lower right zone 120 (labeled down. right in FIG. 1B). Movement of the carrier 104 can cause the emitted optical signals 112 to be steered into these different zones 120 over time on a zone-by-zone basis as explained in greater detail below. While the example of FIG. 1B shows the use of 9 zones 120 within FOI 114, it should be understood that practitioners may choose to employ more or fewer zones 120 if desired. Moreover, the zones 120 need not necessarily be equally sized. Further still, while the example of FIG. 1B shows that zones 120 are non-overlapping, it should be understood that a practitioner may choose to define zones 120 that exhibit some degree of overlap with each other. The use of such overlapping zones can help facilitate the stitching or fusing together of larger lidar frames or point clouds from zone-specific lidar subframes.

The overall FOI 114 for system 100 can be a wide FOI, for example with coverage such as 135 degrees (horizontal) by 135 degrees (vertical). However, it should be understood that wider or narrower sizes for the FOI 114 could be employed if desired by a practitioner. With an example 135 degree by 135 degree FOI 114, each zone 120 could exhibit a sub-portion of the FOI such as 45 degrees (horizontal) by 45 degrees (vertical). However, it should also be understood that wider, e.g. 50×50 degrees or narrower, e.g., 15×15 degrees, sizes for the zones 120 could be employed by a practitioner if desired. Moreover, as noted above, the sizes of the different zones could be non-uniform and/or non-square if desired by a practitioner.

The carrier 104 holds a plurality of light steering optical elements 130 (see FIG. 1C). Each light steering optical element 130 will have a corresponding zone 120 to which is steers the incoming optical signals 112 that are incident thereon. Movement of the carrier 104 causes different light steering optical elements 130 to come into alignment with an optical path of the emitted optical signals 112 over time. This alignment means that the emitted optical signals 112 are incident on the aligned light steering optical element 130. The optical signals 112 incident on the aligned light steering optical element 130 at a given time will be steered by the aligned light steering optical element 130 to flash illuminate a portion of the FOI 114. During the time that a given light steering optical element 130 is aligned with the optical path of the emitted optical signals while the carrier 104 is moving, the emitted optical signals 112 will be steered into the same zone (the corresponding zone 120 of the aligned light steering optical element 130), and the next zone 120 will not be illuminated until a transition occurs to the next light steering optical element 130 becoming aligned with the optical path of the emitted optical signals 112 in response to the continued movement of the carrier 104. Thus, by using different light steering optical elements 130 that provide different steering, the different light steering optical elements 130 can operate in the aggregate to provide steering of the optical signals 112 in multiple directions on a zone-by-zone basis so as to flash illuminate the full FOI 114 over time as the different light steering optical elements 130 come into alignment with the light source 102 as a result of the movement of carrier 104.

As noted above, in an example embodiment, the movement exhibited by the carrier 104 can be rotation 110 (e.g, clockwise or counter-clockwise rotation). With such an arrangement, each zone 120 would correspond to a number of different angular positions for rotation of carrier 104 that define an angular extent for alignment of that zone's corresponding light steering optical element 130 with the emitted optical signals 112. For example, with respect to an example embodiment where the carrier is placed vertically, Zone 1 could be illuminated while the carrier 104 is rotating through angles from 1 degree to 40 degrees with respect to the top, Zone 2 could be illuminated while the carrier 104 is rotating through angles from 41 degrees to 80 degrees, Zone 3 could be illuminated while the carrier 104 is rotating through angles from 81 degrees to 120 degrees, and so on. However, it should be understood that the various zones could have different and/or non-uniform corresponding angular extents with respect to angular positions of the carrier 104. Moreover, as noted above, it should be understood that forms of movement other than rotation could be employed if desired by a practitioner, such as a linear back and forth movement. With linear back and forth movement, each zone 120 would correspond to a number of different movement positions of the carrier 104 that define a movement extent for alignment of that zone's corresponding light steering optical element 130 with the emitted optical signals. However, it should be noted that the rotational movement can be advantageous relative to linear movement in that rotation can benefit from not experiencing a settling time as would be experienced by a linear back and forth movement of the carrier 104 (where the system may not produce stable images during the transient time periods where the direction of back and forth movement is reversed until a settling time has passed).

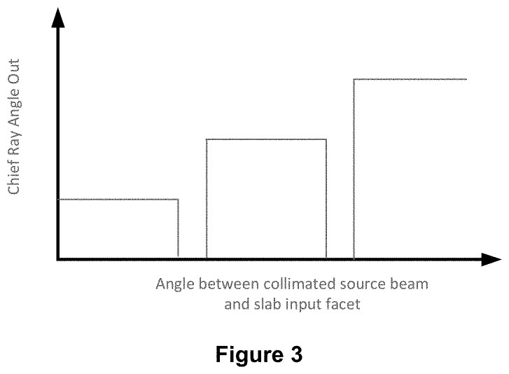

FIG. 1C shows how the arrangement of light steering optical elements 130 on the carrier 104 can govern the zone-by-zone basis by which the lidar system 100 flash illuminates different zones 120 of the FOI 114 over time. For ease of illustration, FIG. 1C shows the light steering optical elements 130 as exhibiting a general sector/pie piece shape. However, it should be understood that other shapes for the light steering optical elements 130 can be employed, such as arc length shapes as discussed in greater detail below. The light steering optical elements 130 can be adapted so that, while the carrier 104 is rotating, collimated 2D optical signals 112 will remain pointed to the same outgoing direction for the duration of time that a given light steering optical element 130 is aligned with the optical path of the optical signals 112. For an example embodiment where the light steering optical elements 130 are rotating about an axis, this means that each light steering optical element 130 can exhibit slopes on their lower and upper facets that remain the same for the incident light during rotation while it is aligned with the optical path of the emitted optical signals 112. FIG. 3 shows a plot of the chief ray angle out for the emitted optical signals 112 versus the angle between the collimated source beam (optical signals 112) and the lower facet of the aligned light steering optical element 130.

In the example of FIG. 1C, the zone 120 labeled “A” is aligned with the light source 102 and thus the optical path of the optical signals 112 emitted by this light source 102. As the carrier 104 rotates in rotational direction 110, it can be seen that, over time, different light steering optical elements 130 of the carrier 104 will come into alignment with the optical signals 112 emitted by light source 102 (where the light source 102 can remain stationary while the carrier 104 rotates). Each of these different light steering optical elements 130 can be adapted to provide steering of incident light thereon into a corresponding zone 120 within the FOI 114. Examples of different architectures that can be employed for the light steering optical elements are discussed in greater detail below. Thus, for the example of FIG. 1C, it should be understood that the time sequence of aligned light steering optical elements with the optical path of optical signals 112 emitted by the light source will be (in terms of the letter labels shown by FIG. 1C for the different light steering optical elements 130): ABCDEFGHI (to be repeated as the carrier 104 continues to rotate). In this example, we can define light steering optical element A as being adapted to steer incident light into the center zone 120, light steering optical element B as being adapted to steer incident light into the left zone 120, and so on as noted in the table of FIG. 1C. Thus, it can be appreciated that the optical signals 112 will be steered by the rotating light steering optical elements 130 to flash illuminate the FOI 114 on a zone-by-zone basis. It should be understood that the zone sequence shown by FIG. 1C is an example only, and that practitioners can define different zone sequences if desired.

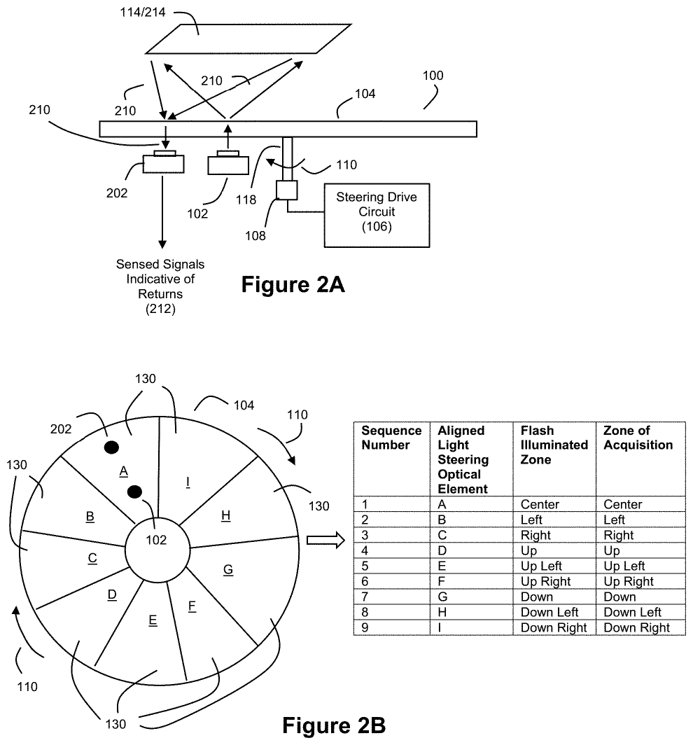

FIG. 2A shows an example where the lidar system 200 also includes a sensor 202 such as a photodetector array that provides zone-by-zone acquisition of returns 210 from a field of view (FOV) 214. Sensor 202 can thus generate zone-specific sensed signals 212 based on the light received by sensor 202 during rotation of the carrier 104, where such received light includes returns 210. It should be understood that FOI 114 and FOV 214 may be the same; but this need not necessarily be the case. For example, the FOV 214 can be smaller than and subsumed within the FOI 114. Accordingly, for ease of reference, the transmission side of the lidar system can be characterized as illuminating the FOV 214 with the optical signals 112 (even if the full FOI 114 might be larger than the FOV 214). The 3D lidar point cloud can be derived from the overlap between the FOI 114 and FOV 214. It should also be understood that returns 210 will be approximately collimated because the returns 210 can be approximated to be coming from a small source that is a long distance away.

In the example of FIG. 2A, it can be seen the plane of sensor 202 is parallel to the plane of rotation for the carrier 104, which means that the axis for the optical path of returns 210 from the carrier 104 to the sensor 202 is perpendicular to the plane of rotation for carrier 104. Likewise, this axis for the optical path of the returns 210 from the carrier 104 to the sensor 202 is parallel to the axis of rotation for the carrier 104 (as well as parallel to the axis for the optical path of the emitted optical signals 112 from the light source 102 to the carrier 104). Moreover, this relationship between the axis for the optical path of returns 210 and the plane of rotation for carrier 104 remains fixed during operation of the system 100.

The zone-specific sensed signals 212 will be indicative of returns 210 from objects in the FOV 214, and zone-specific lidar sub-frames can be generated from signals 212. Lidar frames that reflect the full FOV 214 can then be formed from aggregations of the zone-specific lidar sub-frames. In the example of FIG. 2A, movement (e.g., rotation 110) of the carrier 104 also causes the zone-specific light steering optical elements 130 to become aligned with the optical path of returns 210 on their way to sensor 202. These aligned light steering optical elements 130 can provide the same steering as provided for the emission path so that at a given time the sensor 102 will capture incident light from the zone 120 to which the optical signals 112 were transmitted (albeit where the direction of light propagation is reversed for the receive path).

FIG. 2B shows an example where the light source 102 and sensor 202 are in a bistatic arrangement with each other, where the light source 102 is positioned radially inward from the sensor 202 along a radius from the axis of rotation. In this example, each light steering optical element 130 can have an interior portion that will align with the optical path from the light source 102 during rotation 110 and an outer portion that will align with the optical path to the sensor 202 during rotation 110 (where the light source 102 and sensor 202 can remain stationary during rotation 110). The inner and outer portions of the light steering optical elements can be different portions of a common light steering structure or they can be different discrete light steering optical portions (e.g., an emitter light steering optical element and a paired receiver light steering optical element) that are positioned on carrier 104. It should be understood that the rotational speed of carrier 104 will be very slow relative to the speed at which the optical signals from the light source 102 travel to objects in the FOV 214 and back to sensor 202. This means that cycle time corresponding to a full revolution of carrier 104 relative to the roundtrip time of the optical signals 112 and returns 210 will be much longer so that the vast majority of the returns 210 for emitted optical signals 112 that are transmitted into a given zone 120 will be received by the same light steering optical element 130 that steered the corresponding optical signal 112 in the transmit path. Accordingly, FIG. 2B shows that the time sequence of zones of acquisition by sensor 202 will match up with the zones of flash illumination created by light source 102. Once again, it should be understood that the zone sequence shown by FIG. 2B is an example only, and other zone sequences could be employed.

While FIGS. 2A and 2B show an example where light source 102 and sensor 202 lie on the same radius from the axis of rotation for carrier 104, it should be understood that this need not be the case. For example, sensor 202 could be located on a different radius from the axis of rotation for carrier 104; in which case, the emission light steering optical elements 130 can be positioned at a different angular offset than the receiver light steering optical elements 130 to account for the angular offset of the light source 102 and sensor 202 relative to each other with respect to the axis of rotation for the carrier 104. Moreover, while FIGS. 2A and 2B show an example where sensor 202 is radially outward from the light source 102, this could be reversed if desired by a practitioner where the light source 102 is radially outward from the sensor 202.

Light Source 102:

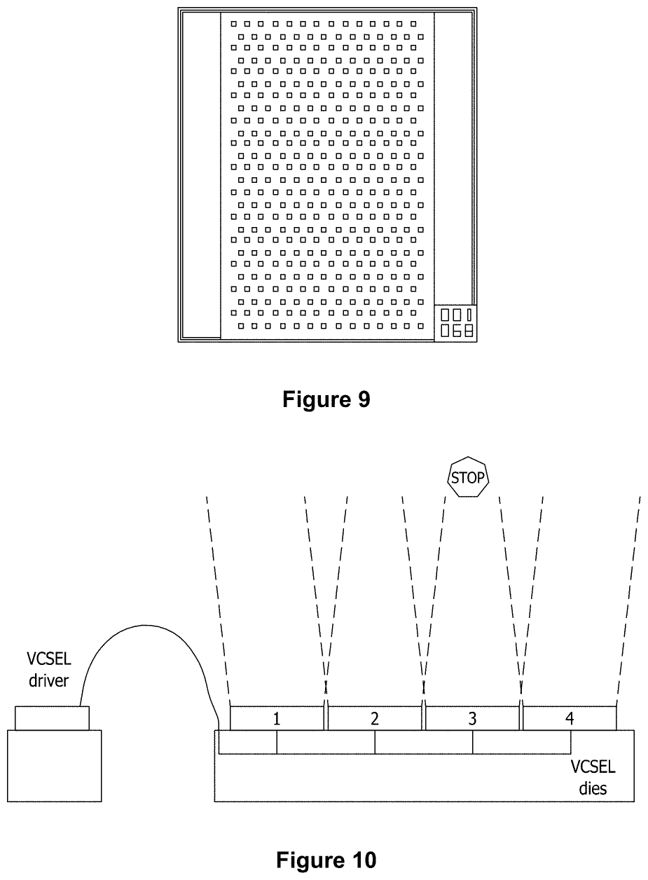

The optical signals 112 can take the form of modulated light such as laser pulses produced by an array of laser emitters. For example, the light source 102 can comprise an array of Vertical Cavity Surface-Emitting Lasers (VCSELs) on one or more dies. The VCSEL array can be configured to provide diffuse illumination or collimated illumination. Moreover, as discussed in greater detail below, a virtual dome technique for illumination can be employed. Any of a number of different laser wavelengths can be employed the light source 102 (e.g., a 532 nm wavelength, a 650 nm wavelength, a 940 nm wavelength, etc. can be employed (where 940 nm can provide CMOS compatibility)). Additional details about example emitters that can be used with example embodiments are described in greater detail in connection with FIGS. 9-10. Furthermore, it should be understood that the light source 102 may comprise arrays of edge-emitting lasers (e.g., edge-emitting lasers arrayed in stacked bricks) rather than VCSELs if desired by a practitioner. Also, the laser light for optical signals 112 need not be pulsed. For example, the optical signals 112 can comprise continuous wave (CW) laser light.

Integrated or hybrid lenses may be used to collimate or otherwise shape the output beam from the light source 102. Moreover, driver circuitry may either be wire-bonded or vertically interconnected to the light source (e.g., VCSEL array).

FIG. 9 shows an example for multi-junction VCSEL arrays that can be used as the light source 102. As an example, Lumentum multi-junction VCSEL arrays can be used, and such arrays can reach extremely high peak power (e.g., in the hundreds of watts) when driven with short, nanosecond pulses at low duty factors (e.g., <1%), making them useful for short, medium, and long-range lidar systems. The multi-junctions in such VCSEL chips reduce the drive current required for emitting multiple photons for each electron. Optical power above 4 W per ampere is common. The emitters are compactly arranged to permit not just high power, but also high power density (e.g., over 1 kW per square mm of die area at 125° C. at 0.1% duty cycle.

FIG. 10 shows an example where the light source 102 can comprise multiple VCSEL dies, and the illumination produced by each die can be largely (although not necessarily entirely, as shown by FIG. 10) non-overlapping. Furthermore, the voltage or current drive into each VCSEL die can be controlled independently to illuminate different regions or portions of a zone with different optical power levels. For example, with reference to FIG. 10, the emitters of the light source 102 can emit low power beams. If the receiver detects a reflective object in a region of a zone corresponding to a particular emitter (e.g., the region corresponding to VCSEL die 3), the driver can reduce the voltage to that emitter (e.g., VCSEL die 3) resulting in lower optical power. This approach can help reduce stray light effects in the receiver. In other words, a particular emitter of the array VCSEL die 3 can be driven to emit a lower power output than the other emitters of the array, which may be desirable if the particular emitter is illuminating a strong reflector such as a stop sign, which can reduce the risk of saturating the receiver.

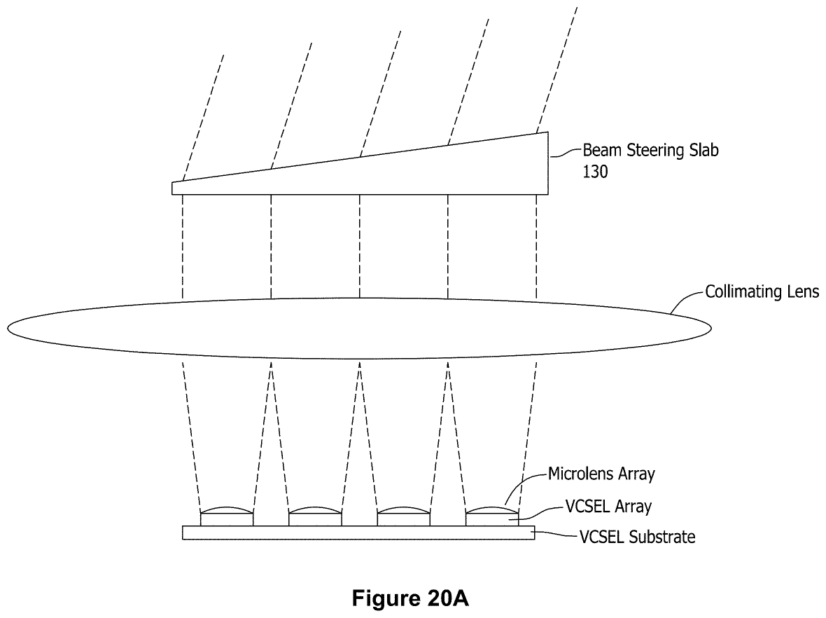

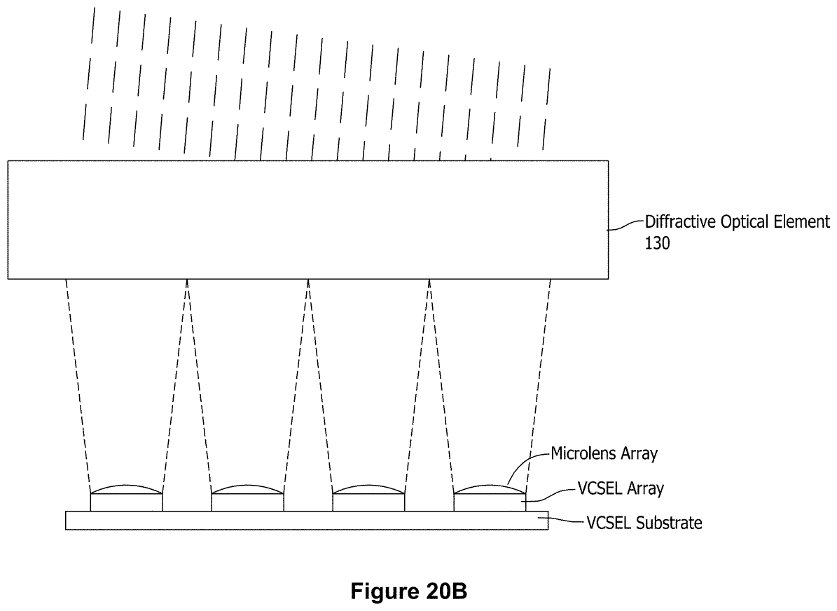

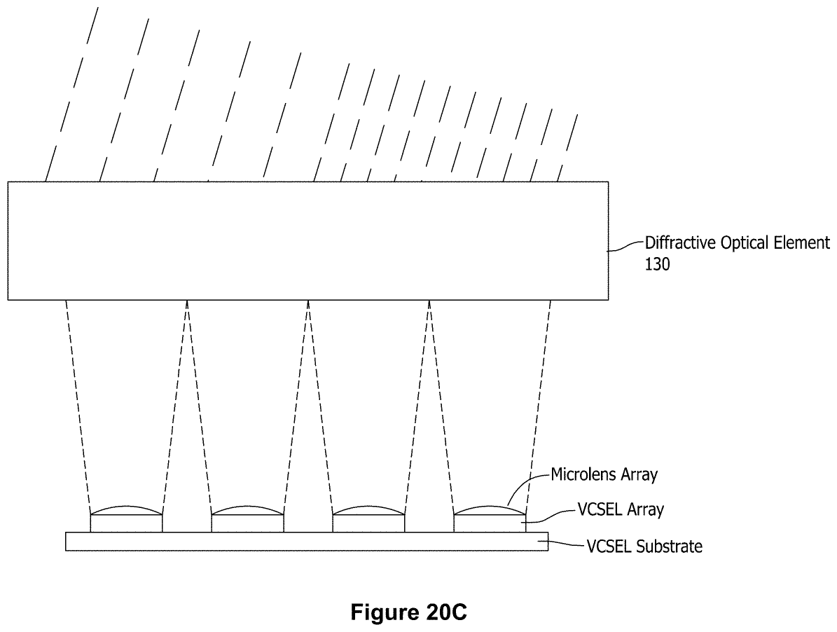

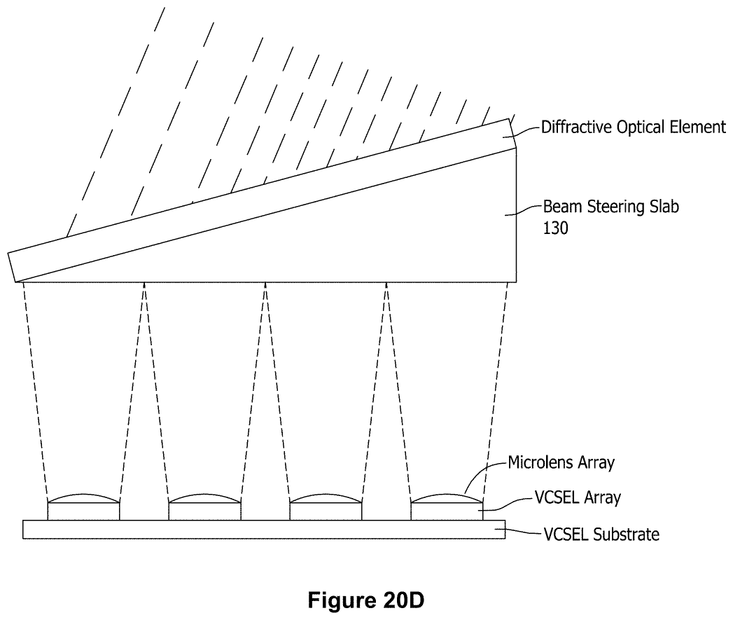

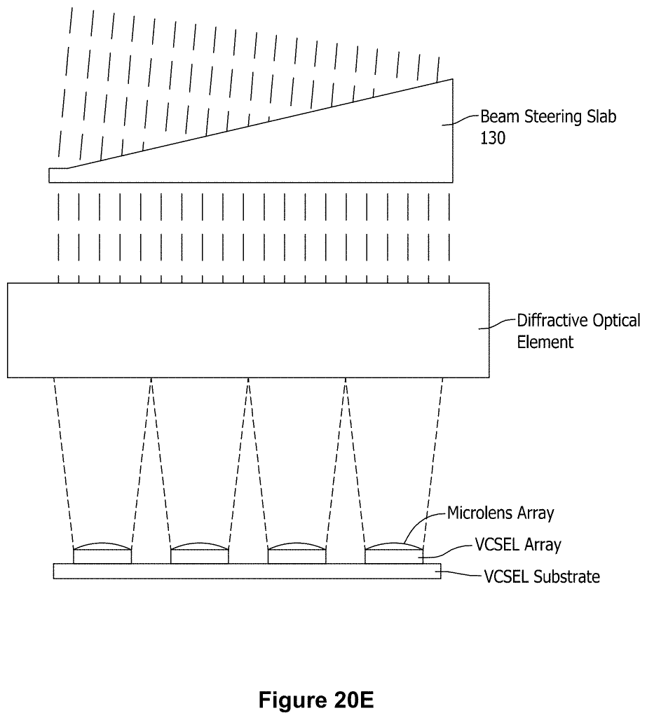

The light source 102 can be deployed in a transmitter module (e.g., a barrel or the like) having a transmitter aperture that outputs optical signals 112 toward the carrier 104 as discussed above. The module may include a microlens array aligned to the emitter array, and it may also include a macrolens such as a collimating lens that collimates the emitted optical signals 112 (e.g., see FIG. 20A); however this need not be the case as a practitioner may choose to omit the microlens array and/or macrolens.

Carrier 104:

The carrier 104 can take any of a number of forms, such as a rotator, a frame, a wheel, a doughnut, a ring, a plate, a disk, or other suitable structure for connecting the light steering optical elements 130 to a mechanism for creating the movement (e.g., a spindle 118 for embodiments where the movement is rotation 110). For example, the carrier 104 could be a rotator in the form of a rotatable structural mesh that the light steering optical elements 130 fit into. As another example, the carrier 104 could be a rotator in the form of a disk structure that the light steering optical elements 130 fit into. The light steering optical elements 130 can be attached to the carrier 104 using any suitable technique for connection (e.g., adhesives (such as glues or epoxies), tabbed connectors, bolts, friction fits, etc.). Moreover, in example embodiments, one or more of the light steering optical elements 130 can be detachably connectable to the carrier 104 and/or the light steering optical elements 130 and carrier 104 can be detachably connectable to the system (or different carrier/light steering optical elements combinations can be fitted to different otherwise-similar systems) to provide different zonal acquisitions. In this manner, users or manufacturers can swap out one or more of the light steering elements (or change the order of zones for flash illumination and collection and/or change the number and/or nature of the zones 120 as desired).

While carrier 104 is movable (e.g., rotatable about an axis), it should be understood that with an example embodiment the light source 102 and sensor 202 are stationary/static with respect to an object that carries the lidar system 100 (e.g., an automobile, airplane, building, tower, etc.). However, for other example embodiments, it should be understood that the light source 102 and/or sensor 202 can be moved while the light steering optical elements 130 remain stationary. For example, the light source 102 and/or sensor 202 can be rotated about an axis so that different light steering optical elements 130 will become aligned with the light source 102 and/or sensor 202 as the light source 102 and/or sensor 202 rotates. As another example, both the light source 102/sensor 202 and the light steering optical elements 130 can be movable, and their relative rates of movement can define when and which light steering optical elements become aligned with the light source 102/sensor 202 over time.

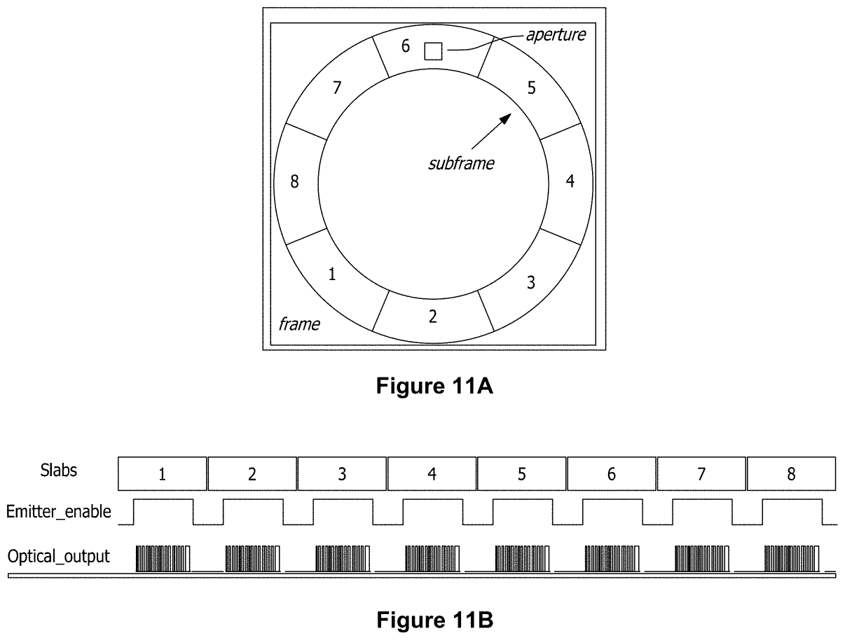

FIGS. 11A-16 provide additional details about example embodiments for carrier 104 and its corresponding light steering optical elements 130.

For example, FIG. 11A shows an example doughnut arrangement for emission light steering optical elements, where different light steering optical elements (e.g., slabs) will become aligned with the output aperture during rotation of the doughnut. Accordingly, each light steering optical element (e.g., slab) can correspond to a different subframe. FIG. 11B shows timing arrangements for alignments of these light steering optical elements 130 with the aperture along with the enablement of emissions by the light source 102 and corresponding optical signal outputs during the times where the emissions are enabled. In the example of FIG. 11B, it can be seen that the light source 102 can be turned off during time periods where a transition occurs between the aligned light steering optical elements 130 as a result of the rotation 110. Furthermore, in an example embodiment, the arc length of each light steering optical element 130 (see the slabs in FIGS. 11A and 11B) is preferably much longer than a diameter of the apertures for the light source 102 and sensor 202 so that (during rotation 110 of the carrier 104) the time that the aperture is aligned with two light steering optical elements 130 at once is much shorter than the time that the aperture is aligned with only one of the light steering optical elements 130.

Further still, FIG. 11A shows an example where each light steering optical element (e.g., slab) has a corresponding angular extent on the doughnut that is roughly equal (40 degrees in this example). Thus, changes in the zone of illumination/acquisition will only occur in a step-wise fashion in units of 40 degrees of rotation by the carrier 104. This means that while the carrier 104 continues to rotate, the zone of illumination/acquisition will not change when rotating through the first 40 degrees of angular positions for the carrier 104, followed by a transition to the next zone for the next 40 degrees of angular positions for the carrier 104, and so on for additional zones and angular positions for the carrier 104 until a complete revolution occurs and the cycle repeats.

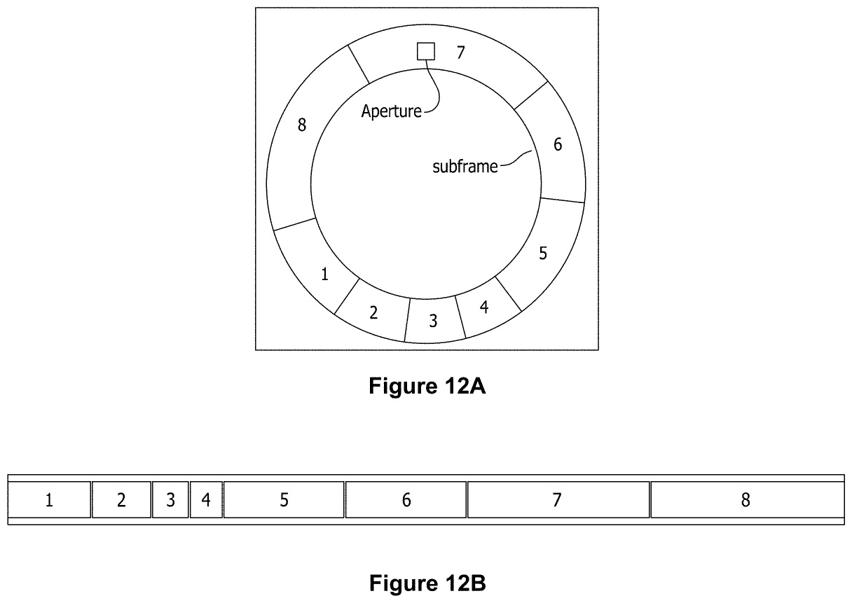

As another example, FIG. 12A shows an example where the angular extents (e.g., the angles that define the arc lengths) of the light steering optical elements 130 (e.g., slabs) can be different. Thus, as compared to the example of FIG. 11A (where the slabs have equivalent arc lengths, in which case the dwell time for the flash lidar system on each zone 120 would be the same assuming a constant rotational rate during operation of the lidar system 100 (excluding initial start-up or slow-down periods when the carrier 104 begins or ends its rotation 110)), the light steering optical elements 130 of FIG. 12A exhibit irregular, non-uniform arc lengths. Some arc lengths are relatively short, while other arc lengths are relatively long. This has the effect of producing a relatively shorter dwell time on zones 120 which correspond to light steering optical elements 130 having shorter arc lengths and relatively longer dwell time on zones 120 which correspond to light steering optical elements 130 having longer arc lengths (see the timeline of FIG. 12B which identifies the timewise sequence of which light steering optical elements (e.g., slabs) are aligned with the aperture over time (not to scale)). This can be desirable to accommodate zones 120 where there is not a need to detect objects at long range (e.g., for zones 102 that correspond to looking down at a road from a lidar-equipped vehicle, there will not be a need for long range detection in which case the dwell time can be shorter because the maximum roundtrip time for optical signals 112 and returns 210 will be shorter) and accommodate zones 102 where is a need to detect objects at long range (e.g., for zones 102 that correspond to looking at the horizon from a lidar-equipped vehicle, there would be a desire to detect objects at relatively long ranges, in which case longer arc lengths for the relevant light steering optical element 130 would be desirable to increase the dwell time for such zones and thus increase the maximum roundtrip time that is supported for the optical signals 112 and returns 210). Further still, this variability in dwell time arising from non-uniform arc lengths for the light steering optical elements 130 can help reduce average and system power as well as reduce saturation.

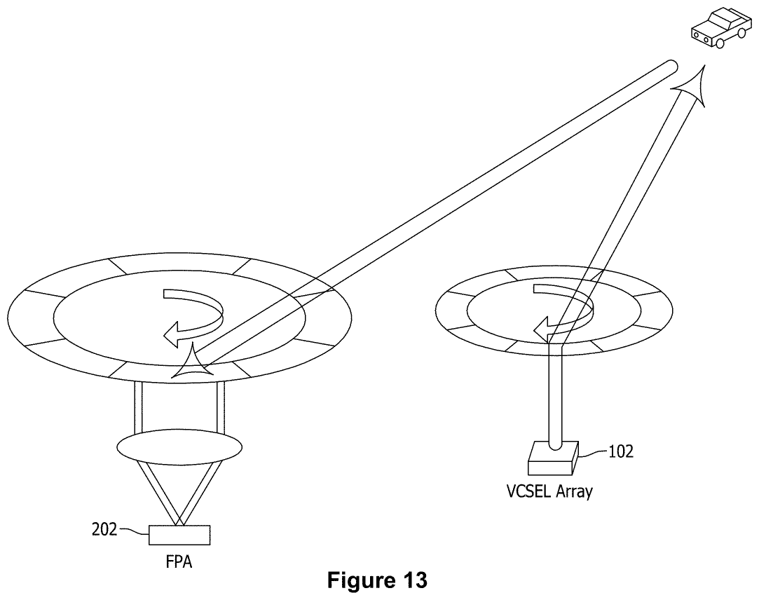

FIG. 13 shows an example where the carrier 104 comprises two carriers—one for transmission/emission and one for reception/acquisition—that are in a bistatic arrangement with each other. These bistatic carriers can be driven to rotate with a synchronization so that the light steering optical element 130 that steers the emitted optical signals 112 into Zone X will be aligned with the optical path of the optical signals 112 from light source 102 for the same time period that the light steering optical element 130 that steers returns 210 from Zone X to the sensor 202 will be aligned with the optical path of the returns 210 to sensor 202. The actual rotational positions of the bistatic carriers 104 can be tracked to provide feedback control of the carriers 104 to keep them in synchronization with each other.

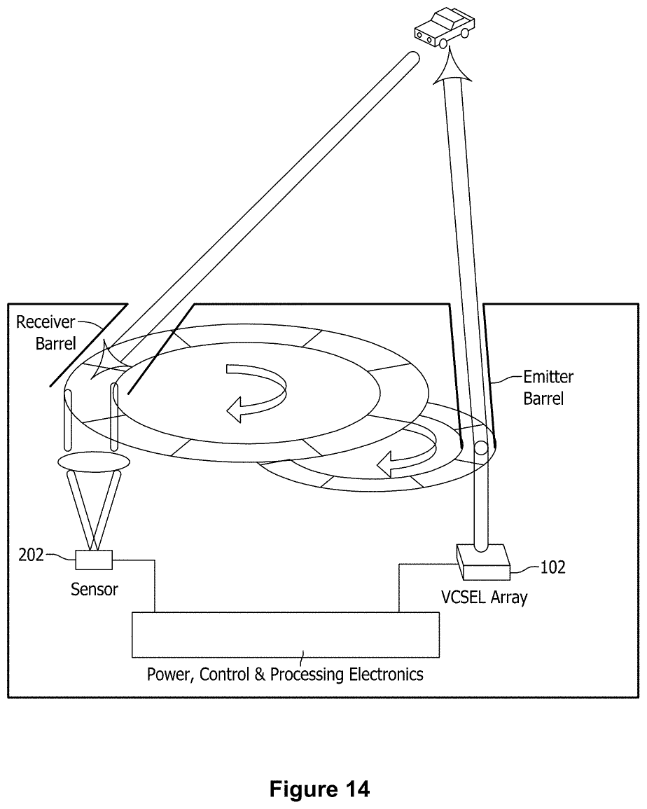

FIG. 14 shows an example where the carriers 104 for transmission/emission and reception/acquisition are in a tiered relationship relative to each other.

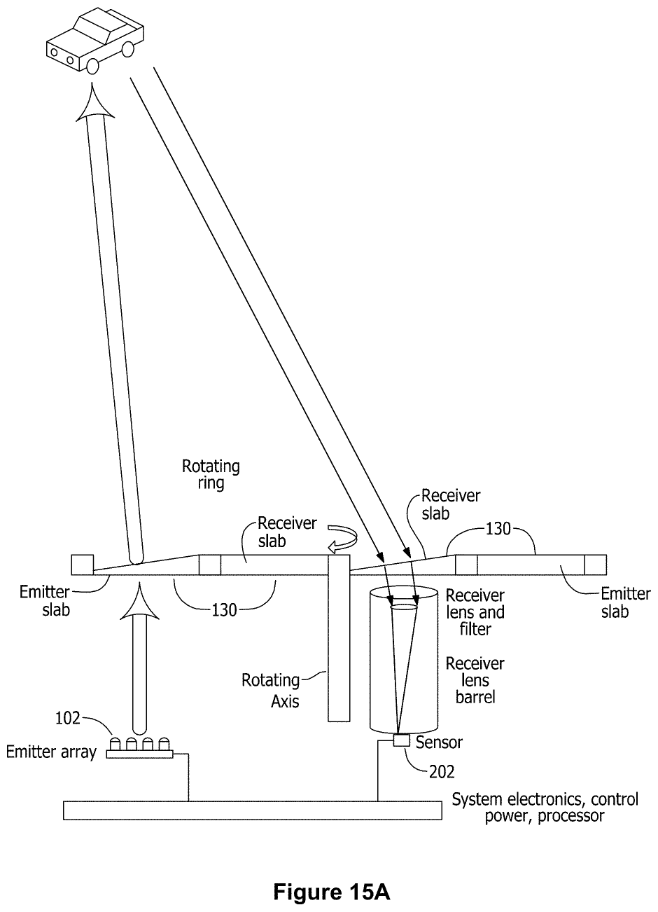

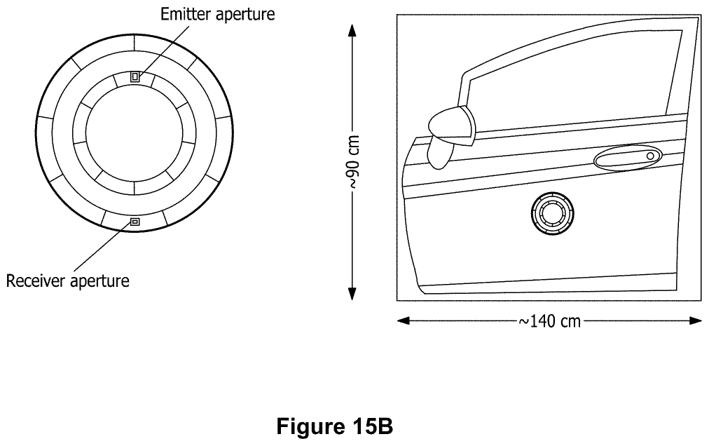

FIG. 15A shows an example where the carriers 104 for transmission/emission and reception/acquisition are concentric relative to each other. This biaxial configuration minimizes the footprint of the lidar system 100. Moreover, the emission/transmission light steering optical elements 130 can be mounted on the same carrier 104 as the receiver/acquisition light steering optical elements 130, which can be beneficial for purposes of synchronization and making lidar system 100 robust in the event of shocks and vibrations. Because the light steering optical elements 130 for both transmit and receive are mounted together, they will vibrate together, which mitigates the effects of the vibrations so long as the vibrations are not too extreme (e.g., the shocks/vibrations would only produce minor shifts in the FOV). Moreover, this ability to maintain operability even in the face of most shocks and vibrations means that the system need not employ complex actuators or motors to drive movement of the carrier 104. Instead, a practitioner can choose to employ lower cost motors given the system's ability to tolerate reasonable amounts of shocks and vibrations, which can greatly reduce the cost of system 100.

FIG. 15B shows an example configuration where the carriers 104 can take the form of wheels and are deployed along the side of a vehicle (such as in a door panel) to image outward from the side of the vehicle. In an example biaxial lidar system with concentric rotating wheels embedded in a car (e.g., in a car door), the emitter area can be 5 mm×5 mm with 25 kW peak output power), the collection aperture can be 7 mm, the arc length of the light steering optical elements can be 10× the aperture diameter, and both the emitter and receiver rings can be mechanically attached to ensure synchronization. With such an arrangement, a practitioner can take care for the external ring to not shadow the light steering optical elements of the receiver.

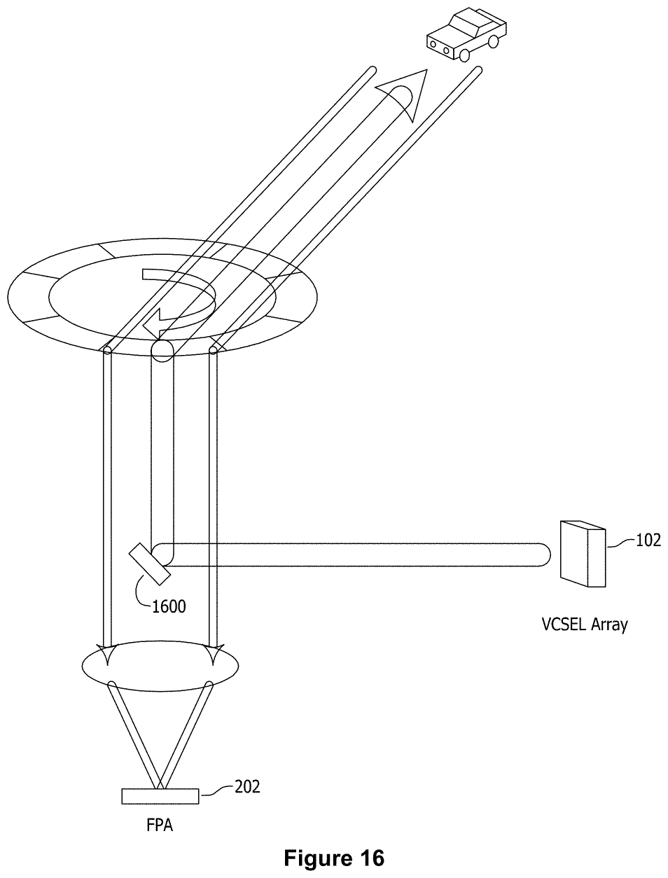

FIG. 16 shows an example where the light source 102 and sensor 202 are monostatic, in which case only a single carrier 104 is needed. A reflector 1600 can be positioned in the optical path for returns from carrier 104 to the sensor 202, and the light source can direct the emitted optical signals 112 toward this reflector 1600 for reflection in an appropriate zone 120 via the aligned light steering optical element 130. With such a monostatic architecture, the receiver aperture can be designed to be larger in order to increase collection efficiency.

Further still, while FIGS. 1C and 2B show examples where one revolution of the carrier 104 would operate to flash illuminate all of the zones 120 of the FOI 114/FOV 214 once; a practitioner may find it desirable to enlarge the carrier 104 (e.g. larger radius) and/or reduce the arc length of the light steering optical elements 130 to include multiple zone cycles per revolution of the carrier 104. With such an arrangement, the sequence of light steering optical elements 130 on the carrier 104 may be repeated or different sequences of light steering optical elements 130 could be deployed so that a first zone cycle during the rotation exhibits a different sequence of zones 120 (with possibly altogether differently shaped/dimensioned zones 120) than a second zone cycle during the rotation, etc.

Light Steering Optical Elements 130:

The light steering optical elements 130 can take any of a number of forms. For example, one or more of the light steering optical elements 130 can comprise optically transmissive material that exhibit a geometry that produces the desired steering for light propagating through the transmissive light steering optical element 130 (e.g., a prism).

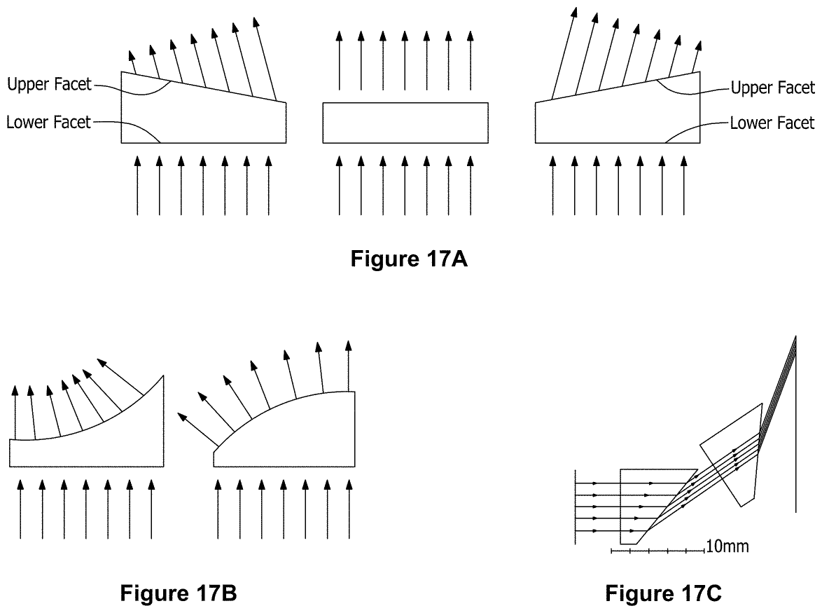

FIGS. 17A-17C show some example cross-sectional geometries that can be employed to provide desired steering. The transmissive light steering optical elements 130 (which can be referenced as “slabs”) can include a lower facet that receives incident light in the form of incoming emitted optical signals 112 and an upper facet on the opposite side that outputs the light in the form of steered optical signals 112 (see FIG. 17A). In order to maintain the zone-by-zone basis by which the lidar system steps through different zones of illumination, the transmissive light steering optical elements should exhibit a 3D shape whereby the 2D cross-sectional slopes of the lower and upper facets relative to the incoming emitted optical signals 112 remain the same throughout its period of alignment with the incoming optical signals 112 during movement of the carrier 104. It should be understood that the designations “lower” and “upper” with respect to the facets of the light steering optical elements 130 refer to their relative proximity to the light source 102 and sensor 202. With respect to acquisition of returns 210, it should be understood that the incoming returns 210 will first be incident on the upper facet, and the steered returns 210 will exit the lower facet on their way to the sensor 202.

With reference to FIG. 17A, the left slab has a 2D cross-sectional shape of a trapezoid and operates to steer the incoming light to the left. The center slab of FIG. 17A has a 3D cross-sectional shape of a rectangle and operates to propagate the incoming light straight ahead (no steering). The right slab of FIG. 17A has a 2D cross-sectional shape of a trapezoid with a slope for the upper facet that is opposite that shown by the left slab, and it operates to steer the incoming light to the right.

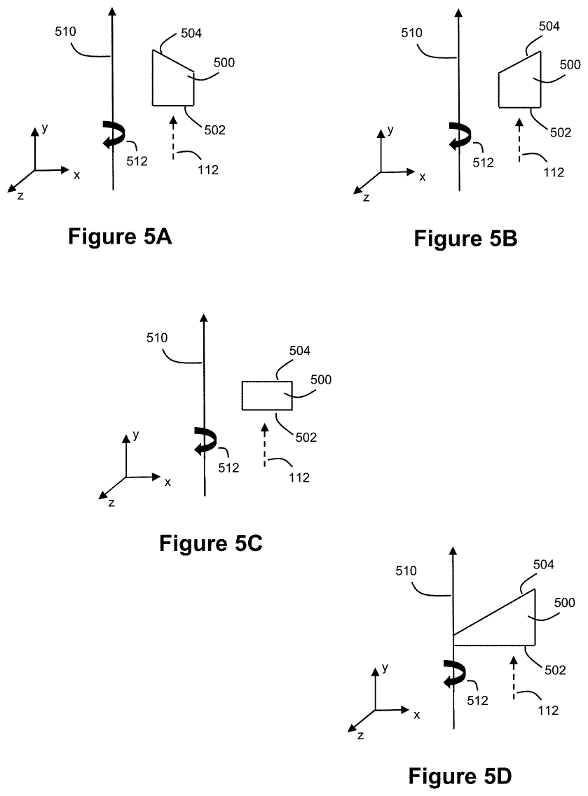

FIG. 5A shows an example of how the left slab of FIG. 17A can be translated into a 3D shape. FIG. 5A shows that the transmissive material 500 can have a 2D cross-sectional trapezoid shape in the xy plane, where lower facet 502 is normal to the incoming optical signal 112, and where the upper facet 504 is sloped downward in the positive x-direction. The 3D shape for a transmissive light steering optical element 130 based on this trapezoidal shape can be created as a solid of revolution by rotating the shape around axis 510 (the y-axis) (e.g., see rotation 512) over an angular extent in the xz plane that defines an arc length for the transmissive light steering optical element 130. It should be understood that the slope of the upper facet 504 will remain the same relative to the lower facet 502 for all angles of the angular extent. As such, the transmissive light steering optical element 130 produced from the geometric shape of FIG. 5A would provide the same light steering for all angles of rotation within the angular extent. In an example where the carrier 104 holds nine transmissive light steering optical elements 130 that correspond to nine zones 120 with equivalent arc lengths, the angular extent for each transmissive light steering optical element 130 would correspond to 40 degrees, and the slopes of the upper facets can be set at magnitudes that would produce the steering of light into those nine zones. These are just examples as it should be understood that practitioners may choose to employ different numbers of zones, in which cases the different slopes for the upper facets of the transmissive light steering optical elements can be employed (and different angular extents for their arc lengths).

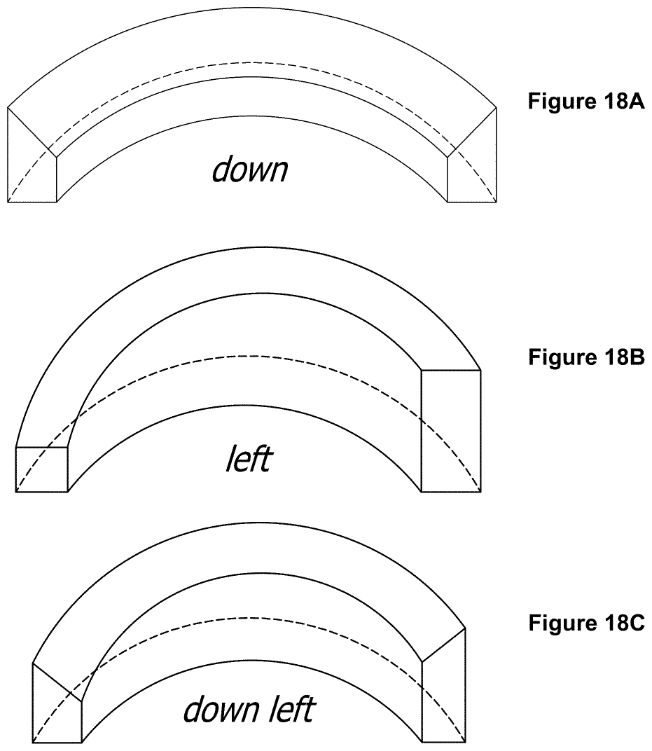

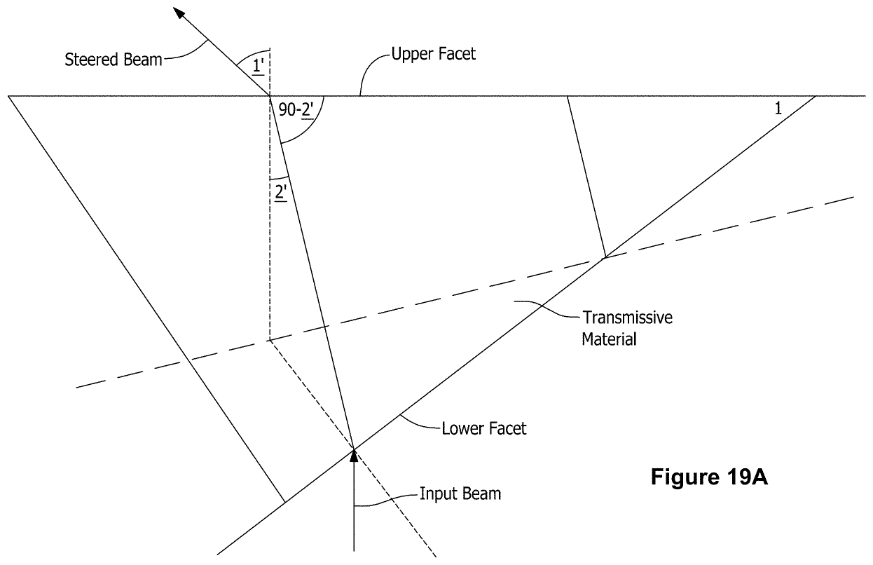

FIG. 5B shows an example of how the right slab of FIG. 17A can be translated into a 3D shape. FIG. 5B shows that the transmissive material 500 can have a 2D cross-sectional trapezoid shape in the xy plane, where lower facet 502 is normal to the incoming optical signal 112, and where the upper facet 504 is sloped upward in the positive x-direction. As with FIG. 5A, the 3D shape for a transmissive light steering optical element 130 based on the trapezoidal shape of FIG. 5B can be created as a solid of revolution by rotating the shape around axis 510 (the y-axis) (e.g., see rotation 512) over an angular extent in the xz plane that defines an arc length for the transmissive light steering optical element 130. As with FIG. 5A, it should be understood that the slope of the upper facet 504 will remain the same relative to the lower facet 502 for all angles of the angular extent. As such, the transmissive light steering optical element 130 produced from the geometric shape of FIG. 5B would provide the same light steering for all angles of rotation within the angular extent. Moreover, as with FIG. 5A, in an example where the carrier 104 holds nine transmissive light steering optical elements 130 that correspond to nine zones 120 with equivalent arc lengths, the angular extent for each transmissive light steering optical element 130 would correspond to 40 degrees. FIG. 18A shows an example 3D rendering of a shape like that shown by FIG. 5B to provide steering in the “down” direction. For frame of reference, the 3D shape produced as a solid of revolution from the shape of FIG. 5A would provide steering in the “up” direction as compared to the slab shape of FIG. 18A.

FIG. 5C shows an example of how the center slab of FIG. 17A can be translated into a 3D shape. FIG. 5C shows that the transmissive material 500 can have a 2D cross-sectional rectangle shape in the xy plane, where lower facet 502 and upper facet 504 are both normal to the incoming optical signal 112. As with FIGS. 5A and 5B, the 3D shape for a transmissive light steering optical element 130 based on the rectangular shape of FIG. 5C can be created as a solid of revolution by rotating the shape around axis 510 (the y-axis) (e.g., see rotation 512) over an angular extent in the xz plane that defines an arc length for the transmissive light steering optical element 130. As with FIGS. 5A and 5B, it should be understood that the slope of the upper facet 504 will remain the same relative to the lower facet 502 for all angles of the angular extent. As such, the transmissive light steering optical element 130 produced from the geometric shape of FIG. 5C would provide the same light steering (which would be non-steering in this example) for all angles of rotation within the angular extent. Moreover, as with FIGS. 5A and 5B, in an example where the carrier 104 holds nine transmissive light steering optical elements 130 that correspond to nine zones 120 with equivalent arc lengths, the angular extent for each transmissive light steering optical element 130 would correspond to 40 degrees.

The examples of FIG. 5A-5C produce solids of revolution that would exhibit a general doughnut or toroidal shape when rotated the full 360 degrees around axis 510 (due to a gap in the middle arising from the empty space between axis 510 and the inner edge of the 2D cross-sectional shape. However, it should be understood that a practitioner need not rotate the shape around an axis 510 that is spatially separated from the inner edge of the cross-sectional shape. For example, FIG. 5D shows can example where the transmissive material 500 has 2D cross-sectional that rotates around an axis 510 that abuts the inner edge of the shape. Rather than producing a doughnut/toroidal shape if rotated over the full 360 degrees, the example of FIG. 5D would produce a solid disk having a cone scooped out of its upper surface. This arrangement would produce the same basic steering as the FIG. 5B example.

It should be understood that the arc shapes corresponding to FIGS. 5A-5C are just examples, and other geometries for the transmissive light steering optical elements 130 could be employed if desired by a practitioner.

For example, FIG. 18B shows an example 3D rendering of an arc shape for a transmissive light steering optical element that would produce “left” steering. In this example, the 2D cross-sectional shape is a rectangle that linearly increases in height from left to right when rotated in the clockwise direction, and where the slope of the upper facet for the transmissive light steering optical element remains constant throughout its arc length. With this arrangement, the slope of the upper facet in the tangential direction would be constant across the arc shape (versus the constant radial slope exhibited by the arc shapes corresponding to solids of revolution for FIGS. 5A, 5B, and 5D). It should be understood that a transmissive light steering optical element that provides “right” steering could be created by rotating a 2D cross-sectional rectangle that linearly decreases in height from left to right when rotated in the clockwise direction.

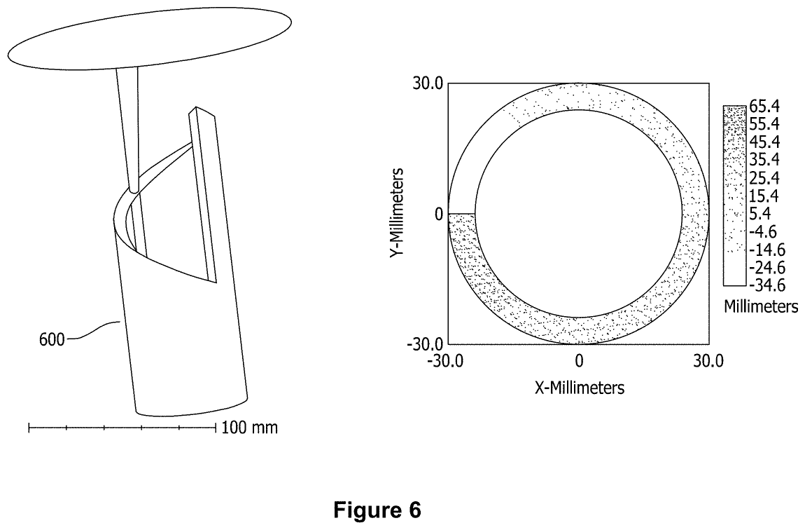

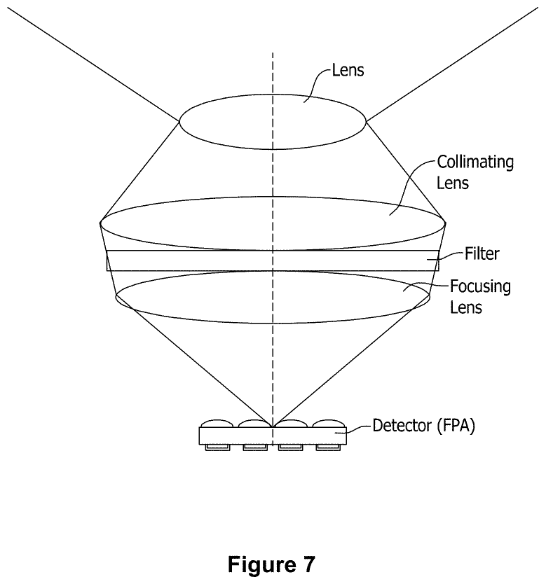

As another example, FIG. 18C shows an example 3D rendering of an arc shape for a transmissive light steering optical element that would produce “down and left” steering. In this example, the 2D cross-sectional shape is a trapezoid like that shown by FIG. 5B that linearly increases in height from left to right when rotated in the clockwise direction, and where the slope of the upper facet for the transmissive light steering optical element remains constant throughout its arc length. With this arrangement, the slope of the upper facet would be non-zero both radially and tangentially on the arc shape. FIG. 6 shows an example rendering of a full solid of revolution 600 for an upper facet whose tangential and radial slopes are non-zero over the clockwise direction (in which case a transmissive light steering optical element could be formed as an arc section of this shape 600). It should be understood that a transmissive light steering optical element that provides “down right” steering could be created by rotating a 2D cross-sectional trapezoid like that shown by FIG. 5B that linearly decreases in height from left to right when rotated in the clockwise direction.

As yet another example, a transmissive light steering optical element that provides “up left” steering can be produced by rotating a 2D cross-sectional trapezoid like that shown by FIG. 5A around axis 510 over an angular extent corresponding to the desired arc length, where the height of the trapezoid linearly increases in height from left to right when rotated around axis 510 in the clockwise direction. In this fashion, the slope of the upper facet for the transmissive light steering optical element would remain constant throughout its arc length. Similarly, a transmissive light steering optical element that provides “up right” steering can be produced by rotating a 2D cross-sectional trapezoid like that shown by FIG. 5A around axis 510 over an angular extent corresponding to the desired arc length, where the height of the trapezoid linearly decreases in height from left to right when rotated around axis 510 in the clockwise direction. In this fashion, the slope of the upper facet for the transmissive light steering optical element would remain constant throughout its arc length.

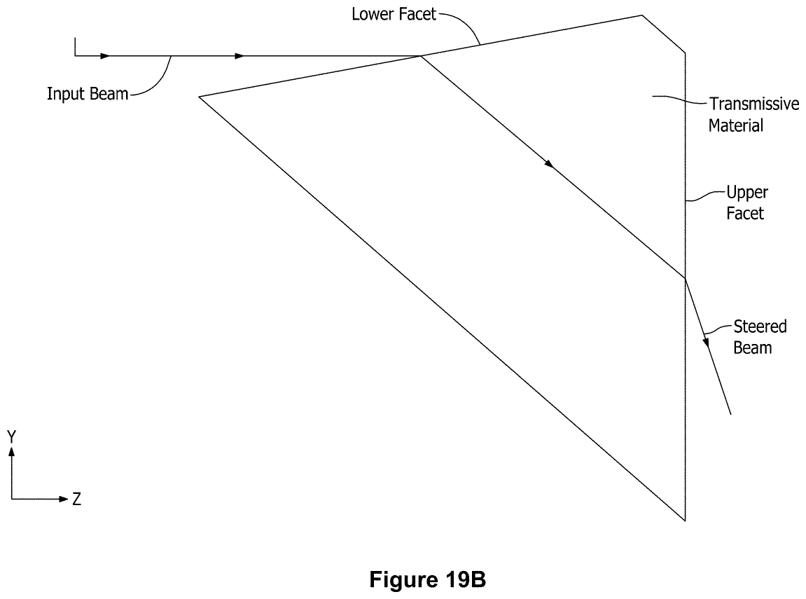

The 2D cross-sectional geometries of the light steering optical elements 130 can be defined by a practitioner to achieve a desired degree and direction of steering; and the geometries need not match those shown by FIGS. 5A-5D and FIGS. 18A-18C. For example, while the examples of FIGS. 5A-5D and FIGS. 18A-18C show examples where the lower facets are normal to the incoming light beams it should be understood that the lower facets need not be normal to the incoming light beams. For example, FIGS. 19A and 19B show additional examples where the lower facet of a transmissive light steering element is not normal to the incoming light beam. In the example of FIG. 19A, neither the lower facet nor the upper facet is normal to the incoming light beam. Such a configuration may be desirable when large deflection angles between incoming and exiting rays is desirable. Other variations are possible. It should be understood that FIGS. 19A and 19B show the slab shapes in cross-section, and an actual 3D transmissive slab can generated for a rotative embodiment by rotating such shapes around an axis 510, maintaining its radial slope, tangential slope, or both slopes.

It should also be understood that facets with non-linear radial slopes could also be employed to achieve more complex beam shapes, as shown by FIG. 17B.

Further still, it should be understood that a given light steering optical element 130 can take the form of a series of multiple transmissive steering elements to achieve higher degree of angular steering, as indicated by the example shown in cross-section in FIG. 17C. For example, a first transmissive light steering optical element 130 can steer the light by a first amount; then a second transmissive light steering optical element 130 that is optically downstream from the first transmissive light steering optical element 130 and separated by an air gap while oriented at an angle relative to the first transmissive light steering optical element 130 (e.g., see FIG. 17C) can steer the light by a second amount in order to provide a higher angle of steering than would be capable by a single transmissive light steering optical element 130 by itself.

FIG. 20A shows an example where the emitted optical signals 112 are propagated through a microlens array on a laser emitter array to a collimating lens that collimates the optical signals 112 prior to being steered by a given transmissive light steering optical element (e.g., a transmissive beam steering slab). The laser emitter array may be frontside illuminating or backside illuminating, and the microlenses may be placed in the front or back sides of the emitter array's substrate.

The transmissive material can be any material that provides suitable transmissivity for the purposes of light steering. For example, the transmissive material can be glass. As another example, the transmissive material can be synthetic material such as optically transmissive plastic or composite materials (e.g., Plexiglas, acrylics, polycarbonates, etc.). For example, Plexiglas is quite transparent to 940 nm infrared (IR) light (for reasonable thicknesses of Plexiglas). Further still, if there is a desire to filter out visible light, there are also types of Plexiglas available that absorb visible light but transmit near-IR light (e.g., G 3142 or 1146 Plexiglas). Plexiglas with desired transmissive characteristics are expected to be available from plastic distributors in various thicknesses, and such Plexiglas is readily machinable to achieve desired or custom shapes. As another example, if a practitioner desires the light steering optical elements 130 to act as a lens or prism rather than just a window, acrylic can be used as a suitable transmissive material. Acrylics can also be optically quite transparent as visible wavelengths if desired and fairly hard (albeit brittle). As yet another example, polycarbonate is also fully transparent to near-IR light (e.g., Lexan polycarbonate).

Furthermore, the transmissive material may be coated with antireflective coating on either its lower facet or upper facet or both if desired by a practitioner.

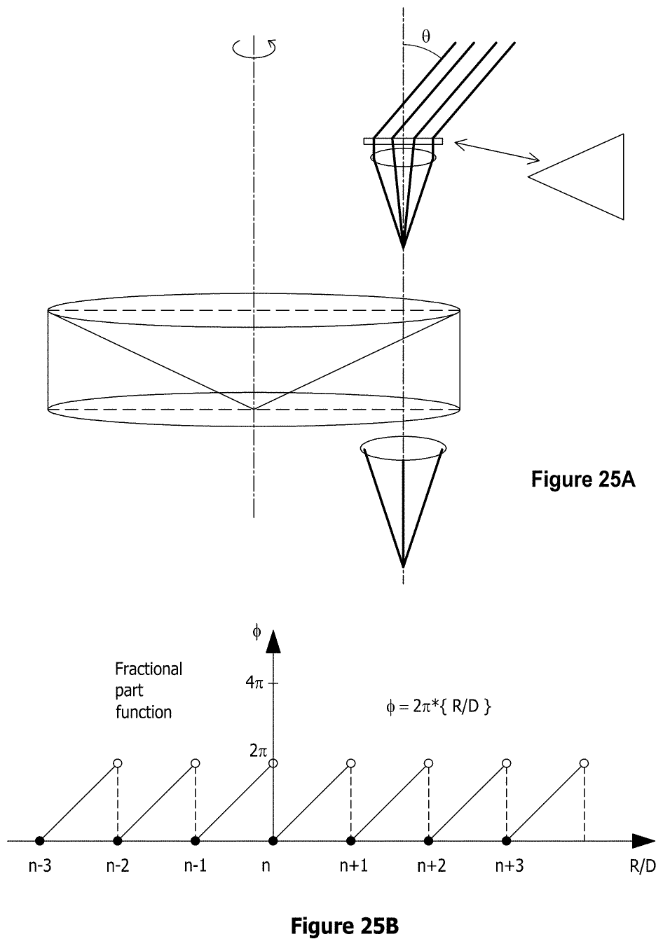

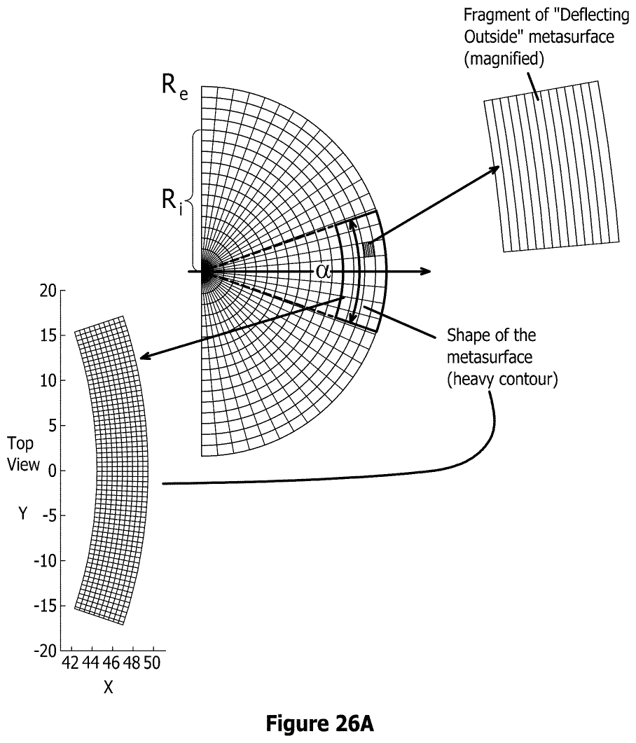

As another example, one or more of the light steering optical elements 130 can comprise diffractive optical elements (DOE) rather than transmissive optical elements (see FIG. 20B; see also FIGS. 25A-37D). Further still, such DOEs can also provide beam shaping as indicated by FIG. 20C. For example, the beam shaping produced by the DOE can produce graduated power density that reduces power density for beams directed toward the ground. The DOEs can diffuse the light from the emitter array so that the transmitted beam is approximately uniform in intensity across its angular span. The DOE may be a discrete element or may be formed and shaped directly on the slabs.

As an example embodiment, each DOE that serves as a light steering optical element 130 can be a metasurface that is adapted to steer light with respect to its corresponding zone 120. For example, a DOE used for transmission/emission can be a metasurface that is adapted to steer incoming light from the light source 102 into the corresponding static zone 120 for that DOE; and a DOE used for reception can be a metasurface that is adapted to steer incoming light from the corresponding zone 120 for that DOE to the sensor 202. A metasurface is a material with features spanning less than the wavelength of light (sub-wavelength features; such as sub-wavelength thickness) and which exhibits optical properties that introduce a programmable phase delay on light passing through it. In this regard, the metasurfaces can be considered to act as phase modulation elements in the optical system. Each metasurface's phase delay can be designed to provide a steering effect for the light as discussed herein; and this effect can be designed to be rotationally-invariant as discussed below and in connection with FIGS. 25A-37D. Moreover, the metasurfaces can take the form of metalenses. In either case and without loss of generality, the sub-wavelength structures that comprise the metasurface can take the form of nanopillars or other nanostructures of defined densities. Lithographic techniques can be used to imprint or etch desired patterns of these nanostructures onto a substrate for the metasurface. As examples, the substrate can take the form of glass or other dielectrics (e.g., quartz, etc.) arranged as a flat planar surface. Due to their thin and lightweight nature, the use of metasurfaces as the light steering optical elements 130 is advantageous because they can be designed to provide a stable rotation while steering beams in a rotationally-invariant fashion, which enables the illumination or imaging of static zones while the metasurfaces are rotating. For example, where the light steering optical elements 130 take the form of transmissive components such as rotating slabs (prisms), these slabs/prisms will suffer from limitations on the maximum angle by which they can deflect light (due to total internal reflection) and may suffer from imperfections such as surface roughness, which reduces their optical effectiveness. However, metasurfaces can be designed in a fashion that provides for relatively wider maximum deflection angles while being largely free of imperfections such as surface roughness.

In example embodiments, the metasurfaces can be arranged on a flat planar disk (or pair of flat planar disks) or other suitable carrier 104 or the like that rotates around the axis of rotation to bring different metasurfaces into alignment with the emitter and/or receiver apertures over time as discussed above.

A phase delay function can be used to define the phase delay properties of the metasurface and thus control the light steering properties of the metasurface. In this fashion, phase delay functions can be defined to cause different metasurfaces to steer light to or from its corresponding zone 120. In example embodiments where movement of the light steering elements 130 is rotation 110, the phase delay functions that define the metasurfaces are rotationally invariant phase delay functions so the light is steered to or from each metasurface's corresponding zone during the time period where each metasurface is aligned with the emitter or receiver. These phase delay functions can then be used as parameters by which nanostructures are imprinted or deposited on the substrate to create the desired metasurface. Examples of vendors which can create metasurfaces according to defined phase delay functions include Metalenz, Inc. of Boston, Mass. and NIL Technology ApS of Kongens Lyngby, Denmark. As examples, a practitioner can also define additional features for the metasurfaces, such as a transmission efficiency, a required rejection ratio of higher order patterns, an amount of scattering from the surface, the materials to be used to form the features (e.g., which can be dielectric or metallic), and whether anti-reflection coating is to be applied.

The discussion below in connection with FIGS. 25A-37D describes examples of how phase delay functions can be defined for an example embodiment to create metasurfaces for an example lidar system which employs 9 zones 120 as discussed above.

Regarding light steering, we can consider the steering in terms of radial and tangential coordinates with respect to the axis of rotation for the metasurface.

In terms of radial steering, we can steer the light away from the center of rotation or toward the center of rotation. If the metasurface's plane is vertical, the steering of light away and toward the center of rotation would correspond to the steering of light in the up and down directions respectively. To achieve such radial steering via a prism, the prism would need to maintain a constant radial slope on a facet as the prism rotates around the axis of rotation, which can be achieved by taking a section of a cone (which can be either the internal surface or the external surface of the cone depending on the desired radial steering direction). Furthermore, we can maintain a constant radial slope of more than one facet—for example, the prism may be compound (such as two prisms separated by air)—to enable wide angle radial steering without causing total internal reflection.

In terms of tangential steering, we can steer the light in a tangential direction in the direction of rotation or in a tangential direction opposite the direction of rotation. If the metasurface's plane is vertical, the steering of light tangentially in the direction of rotation and opposite the direction of rotation would correspond to the steering of light in the right and left directions respectively. To achieve such tangential steering via a prism, we want to maintain a constant tangential slope as the prism rotates around the axis of rotation, which can be achieved by taking a section of a screw-shaped surface.

Further still, one can combine radial and tangential steering to achieve diagonal steering. This can be achieved by combining prism pairs that provide radial and tangential steering to produce steering in a desired diagonal direction.

A practitioner can define a flat (2D) prism that would exhibit the light steering effect that is desired for the metasurface. This flat prism can then be rotated around an axis of rotation to add rotational symmetry (and, if needed, translational symmetry) to create a 3D prism that would produce the desired light steering effect. This 3D prism can then be translated into a phase delay equation that describes the desired light steering effect. This phase delay equation can be expressed as a phase delay plot (Z=ϕ(X,Y)). This process can then be repeated to create the phase delay plots for each of the 9 zones 120 (e.g., an upper left zone, upper zone, upper right zone, a left zone, a central zone (for which no metasurface need be deployed as the central zone can be a straight ahead pass-through in which case the light steering optical element 130 can be the optically transparent substrate that the metasurface would be imprinted on), a right zone, a lower left zone, a lower zone, and a lower right zone).

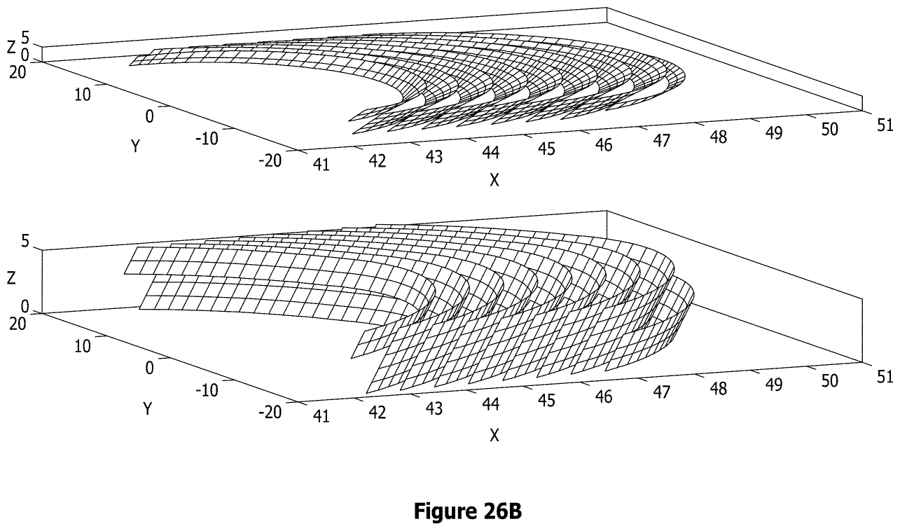

FIGS. 25A, 25B, 26A, and 26B show an example of how a phase delay function can be defined for a metasurface to steer a light beam into the upper zone. A flat prism with the desired effect of steering light outside (away from) the rotation axis can be defined, and then made rotationally symmetric about the axis of rotation to yield a conic shape like that shown in FIG. 25A. The phase delay is proportional to the distance R, where R is the distance of the prism from the axis of rotation, and where R can include a radius to the inner surface of the prism (Rᵢ) and a radius to the external surface of the prism (Rₑ)). This conic shape can be represented by the phase delay function expression:

$$ϕ ( X , Y ) = \frac{2 π * R}{D} = \frac{2 π * \sqrt{{X}^{2} + {Y}^{2}}}{D}$$

$$where :$$

$$D = \frac{λ}{sin θ}$$

where ϕ(X,Y) represents the phase delay ϕ at coordinates X and Y of the metasurface, where λ is the laser wavelength, where θ is the deflection angle (e.g., see FIG. 25A), and where D is a period of diffracting grating which deflects normally incident light of the wavelength λ by the angle θ. For metasurface phase delay as a function of X,Y, one can subtract n*2π, where n is an integer number (see FIG. 25B).

FIG. 26A shows an example configuration for a metasurface that steers light into the upper zone. It should be understood that the images of FIG. 26A are not drawn to scale. For example, for sample values of θ=40° and λ=0.94 μm, the spatial frequency of phase steps would be 342 times greater.

As an example, one can use approximate sizes such as Rₑ=50 mm, Rᵢ=45 mm, and α=40° (which is approximately 0.70 rad) (see FIG. 26A). Furthermore, consider the conic surface equations:

X=R sin(t)

Y=R cos(t)

Z=C*R; (C=const>0)

In this case:

45 mm R<50 mm; −0.35 rad<t<0.35 rad

One can then compare with:

$$ϕ ( X , Y ) = \frac{2 π * R}{D} : \to C = \frac{2 π}{D} = sin θ \frac{2 π}{λ}$$

As shown by FIG. 26B, one can then subtract n*2π where n is an integer number to yield the configuration of:

$$ϕ ( X , Y ) = Z = 2 π \{ \frac{sin θ \sqrt{{X}^{2} + {Y}^{2}}}{λ} \}$$

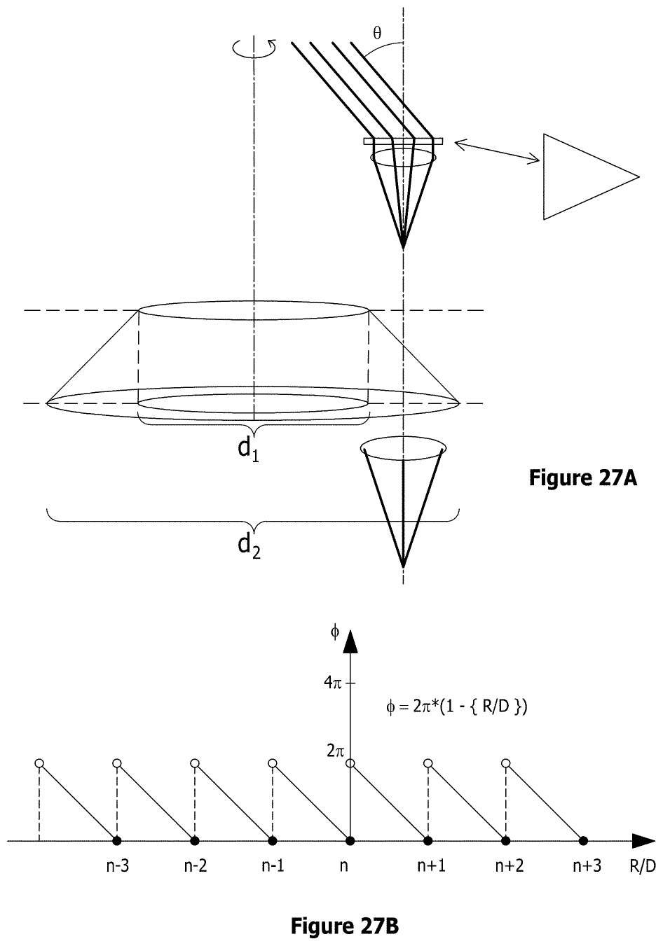

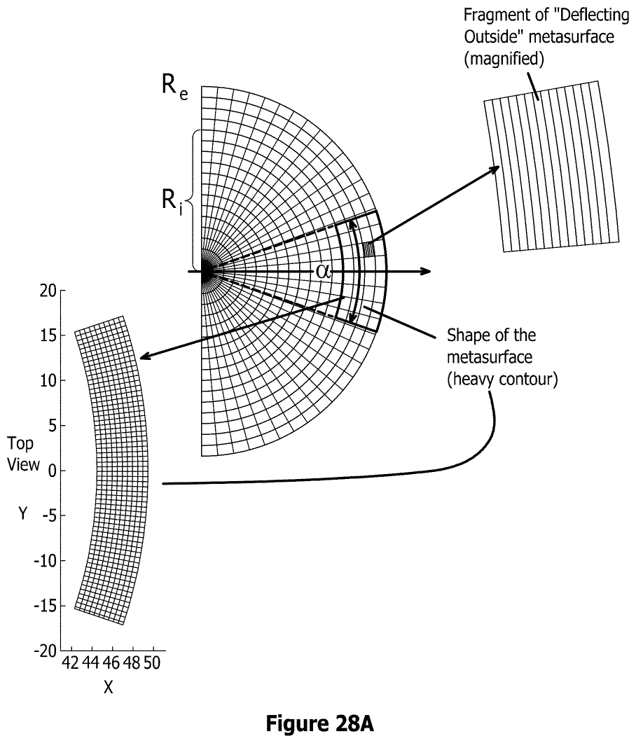

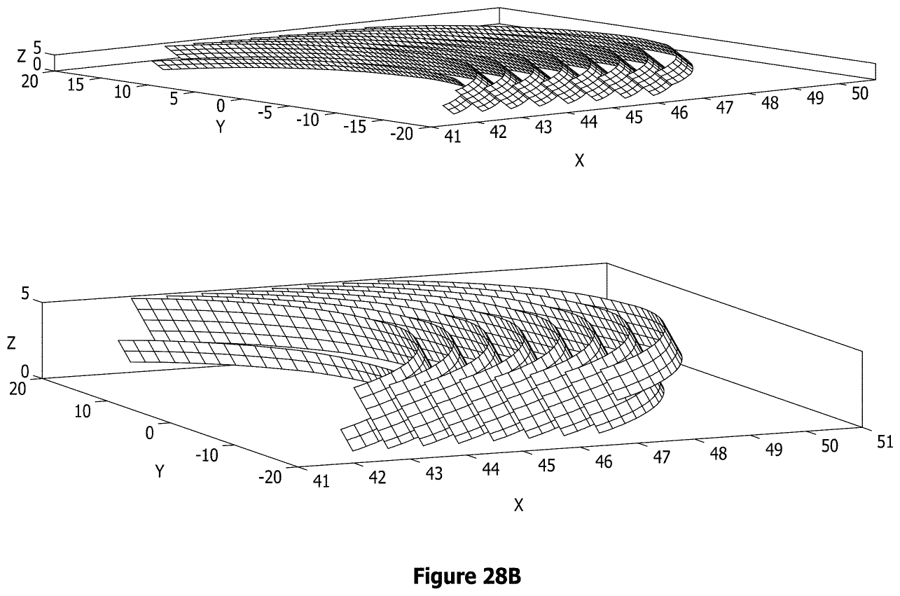

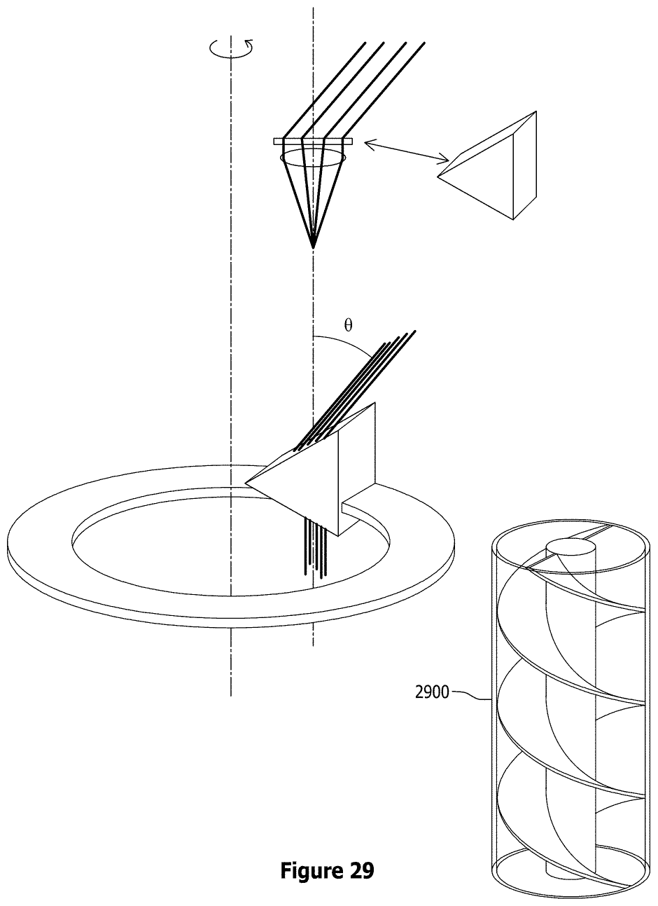

FIGS. 27A, 27B, 28A, and 28B show an example of how a phase delay function can be defined for a metasurface to steer a light beam into the lower zone. A flat prism with the desired effect of steering light inside (toward) the rotation axis can be defined, and then made rotationally symmetric about the axis of rotation to yield a conic shape like that shown in FIG. 27A. This conic shape can be represented by the phase delay function expression:

$$ϕ ( X , Y ) = - \frac{2 π * R}{D} = - \frac{2 π * \sqrt{{X}^{2} + {Y}^{2}}}{D}$$

For metasurface phase delay as a function of X,Y, one can subtract n*2π, where n is an integer number (see FIG. 27B):

$$ϕ ( X , Y ) = 2 π * ( 1 - \{ \frac{R}{D} \} ) = 2 π * ( 1 - \{ \frac{\sqrt{{X}^{2} + {Y}^{2}}}{D} \} )$$

FIG. 28A shows an example configuration for a metasurface that steers light into the lower zone. As noted above in connection with FIG. 26A, it should be understood that the images of FIG. 28A are not drawn to scale.

As an example, one can use approximate sizes such as Rₑ=50 mm, Rᵢ=45 mm, and α=40° (which is approximately 0.70 rad) (see FIG. 28A). Furthermore, consider the conic surface equations:

X=R sin(t)

Y=R cos(t)

Z=C*(−R); (C=const>0)

One can then compare with:

$$ϕ ( X , Y ) = \frac{2 π * R}{D} : \to C = \frac{2 π}{D} = sin θ \frac{2 π}{λ}$$

As shown by FIG. 28B, one can then subtract n*2π where n is an integer number to yield the configuration of:

$$ϕ ( X , Y ) = Z = 2 π * ( 1 - \{ \frac{sin θ \sqrt{{X}^{2} + {Y}^{2}}}{λ} \} )$$

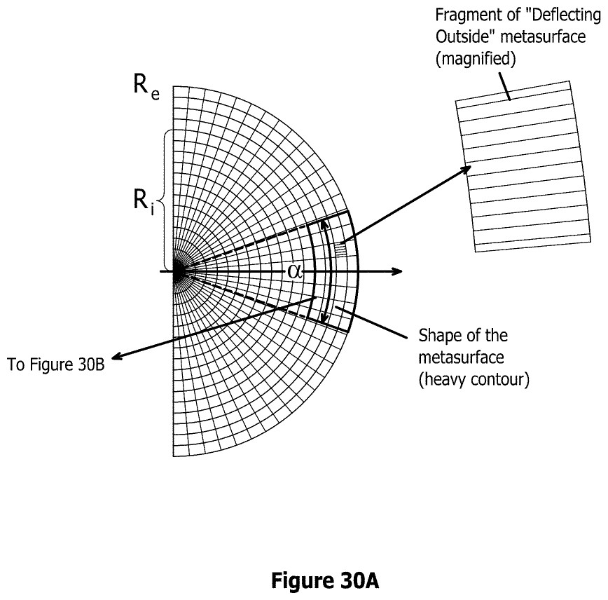

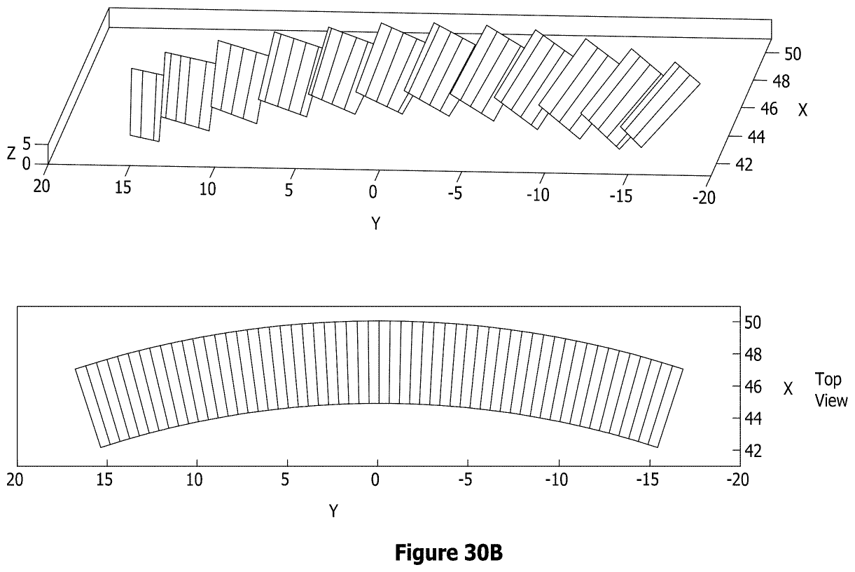

FIGS. 29, 30A, and 30B show examples of how a phase delay function can be defined for a metasurface to steer a light beam into the right zone. A prism oriented tangentially as shown by FIG. 29 with the desired effect of steering light can be defined, and then made rotationally symmetric about the axis of rotation to yield a left-handed helicoid shape 2900 like that shown in FIG. 29. FIGS. 29, 30A, and 30B further show how a phase delay function (ϕ(X,Y)) can be defined for this helicoid shape 2900. The phase delay is proportional to the tangential distance R*t. Since there is a range of R, we can take the intermediate value (using the values of Rₑ=50 mm and Rᵢ=45 mm):

$${R}_{0} = \frac{( {R}_{MAX} + {R}_{MIN} )}{2} = 47.5 mm$$

The helicoid shape 2900 can be represented by the phase delay function expression:

$$ϕ ( X , Y ) = \frac{2 π * {R}_{0} t}{D} ; t = atan ( \frac{X}{Y} )$$

For metasurface phase delay as a function of X,Y, one can subtract n*2π, where n is an integer number to yield:

$$ϕ ( X , Y ) = \frac{2 π * {R}_{0} t}{D} = 2 π * \{ \frac{{R}_{0} a tan ( \frac{X}{Y} )}{D} \}$$

FIG. 30A shows an example configuration for a metasurface that steers light into the right zone. It should be understood that the images of FIG. 30A are not drawn to scale.

As an example, one can use approximate sizes such as Rₑ=50 mm, Rᵢ=45 mm, and α=40° (which is approximately 0.70 rad). Furthermore, consider the helicoid surface equations:

X=R sin(t)

Y=R cos(t)

Z=C*t; (C=const)

One can then compare with:

$$ϕ ( X , Y ) = \frac{2 π * {R}_{0} t}{D} : \to C = \frac{2 π {R}_{0}}{D} = {R}_{0} sin θ \frac{2 π}{λ}$$

As shown by FIG. 30B, one can then subtract n*2π where n is an integer number to yield the configuration of:

$$ϕ ( X , Y ) = Z = 2 π * \{ sin θ {R}_{0} \frac{a tan ( \frac{X}{Y} )}{λ} \}$$

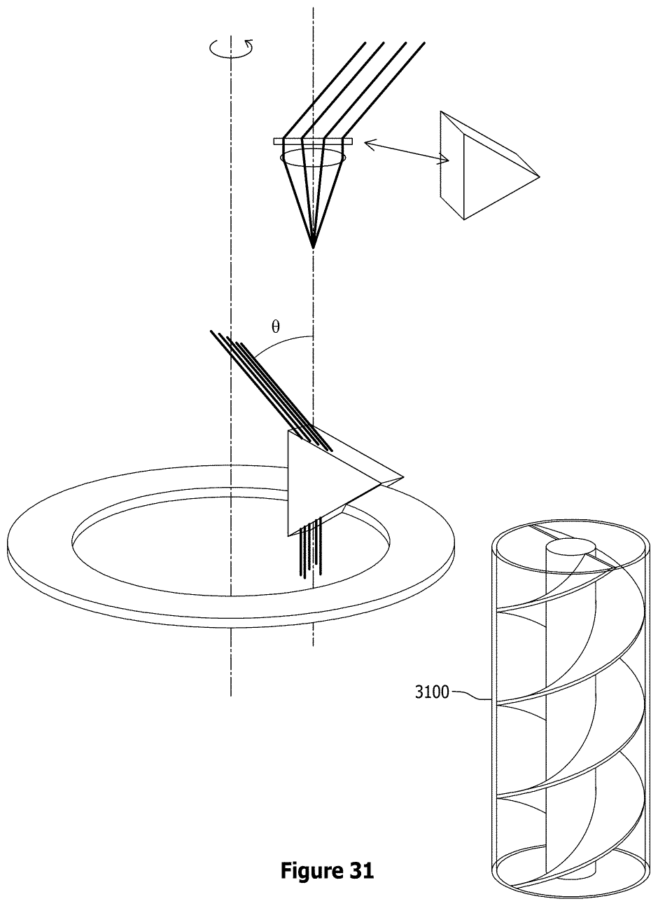

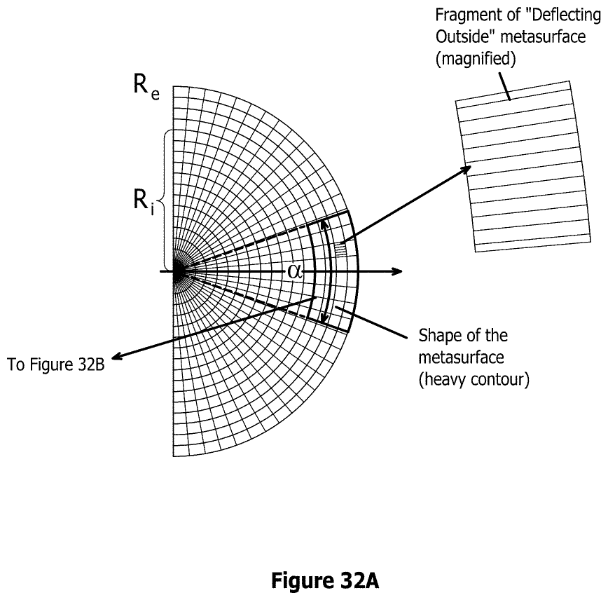

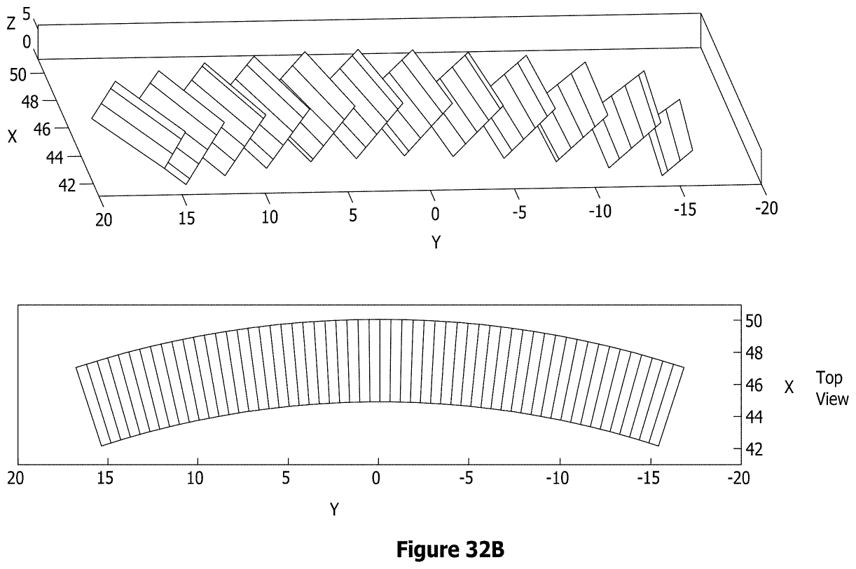

FIGS. 31, 32A, and 32B show examples of how a phase delay function can be defined for a metasurface to steer a light beam into the left zone. A prism oriented tangentially as shown by FIG. 31 with the desired effect of steering light can be defined, and then made rotationally symmetric about the axis of rotation to yield a right-handed helicoid shape 3100 like that shown in FIG. 31. FIGS. 31, 32A, and 32B further show how a phase delay function (ϕ(X,Y)) can be defined for this helicoid shape 3100.

The helicoid shape 3100 can be represented by the phase delay function expression:

$$ϕ ( X , Y ) = - \frac{2 π * {R}_{0} t}{D}$$

For metasurface phase delay as a function of X,Y, one can subtract n*2π, where n is an integer number to yield:

$$ϕ ( X , Y ) = 2 π * ( 1 - \{ \frac{{R}_{0} a tan ( \frac{X}{Y} )}{D} \} )$$

FIG. 32A shows an example configuration for a metasurface that steers light into the left zone. It should be understood that the images of FIG. 32A are not drawn to scale.

As an example, one can use approximate sizes such as Rₑ=50 mm, Rᵢ=45 mm, and α=40° (which is approximately 0.70 rad). Furthermore, consider the helicoid surface equations:

X=R sin(t)

Y=R cos(t)

Z=C*t; (C=const)

One can then obtain:

$$C = \frac{2 π {R}_{0}}{D} = {R}_{0} sin θ \frac{2 π}{λ}$$

As shown by FIG. 32B, one can then subtract n*2π where n is an integer number to yield the configuration of:

$$ϕ ( X , Y ) = Z = 2 π * ( 1 - \{ sin θ {R}_{0} \frac{a tan ( \frac{X}{Y} )}{λ} \} )$$

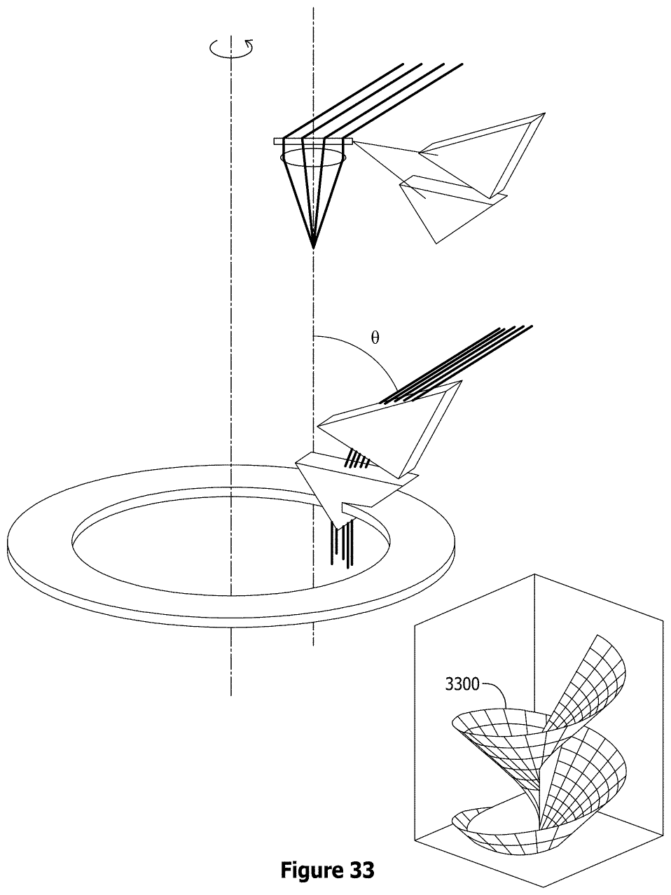

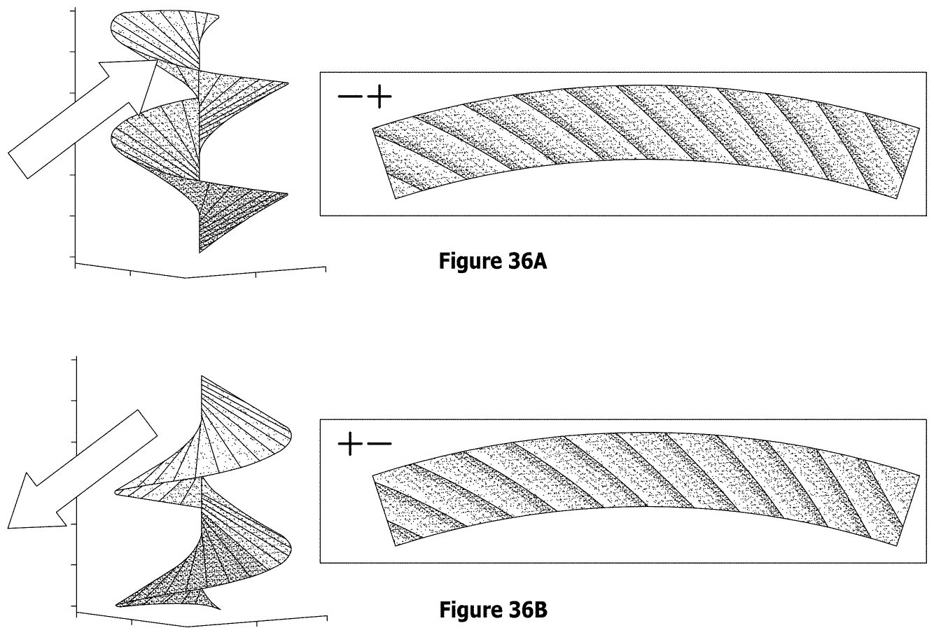

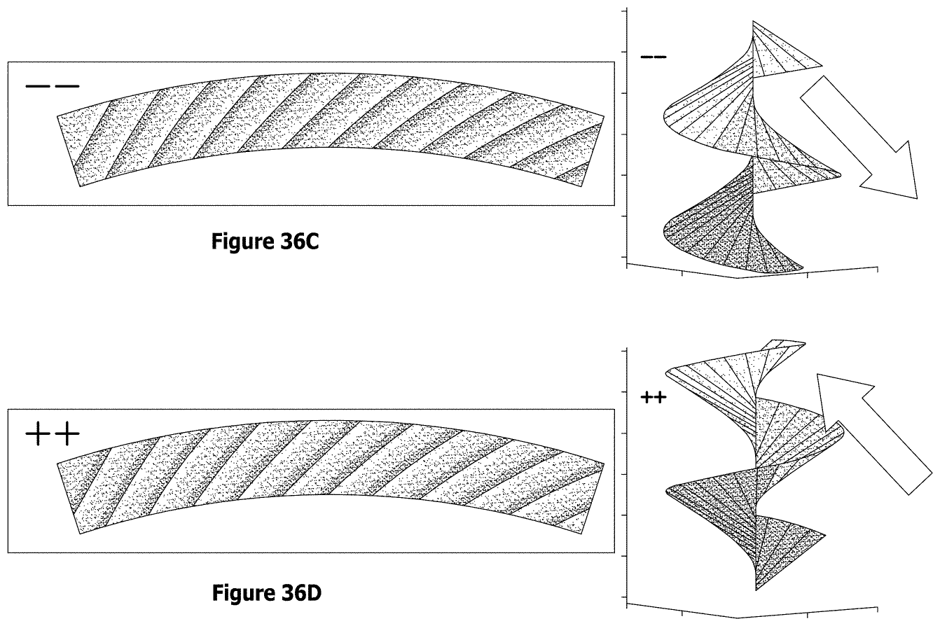

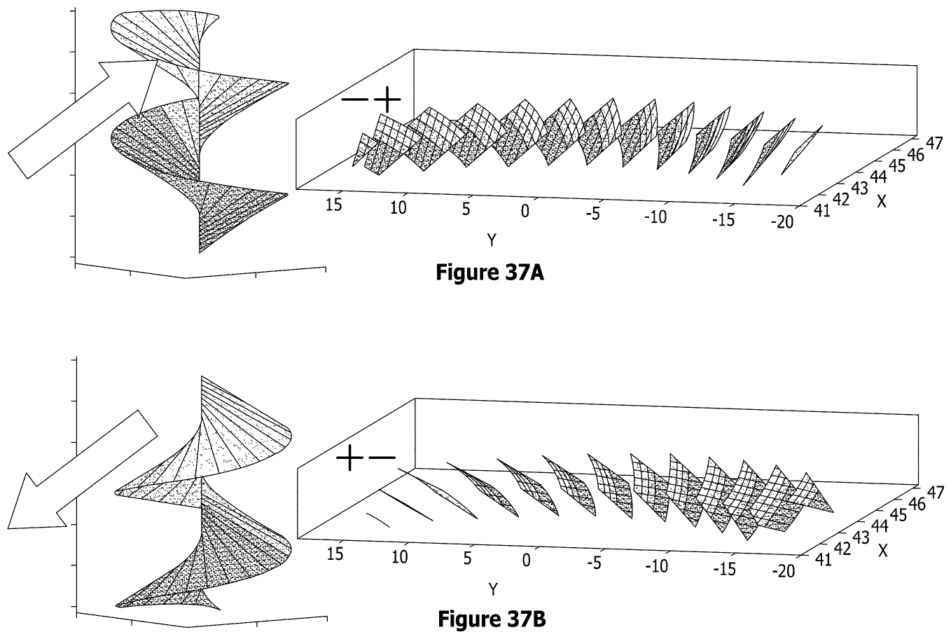

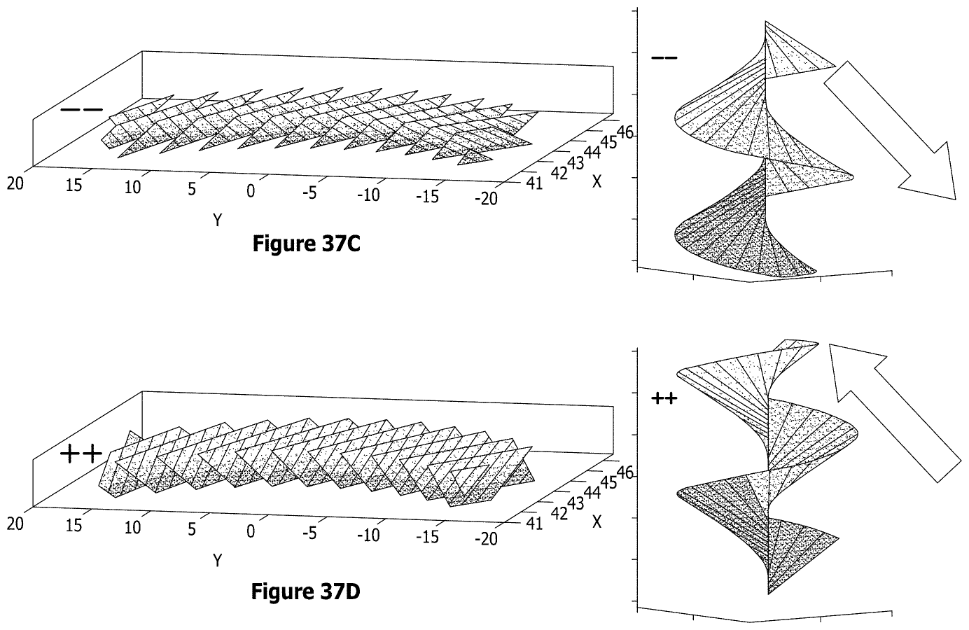

FIGS. 33-37D show examples of how phase delay functions can be defined for metasurfaces to steer a light beam diagonally into the corners of the field of illumination/field of view (the upper left, upper right, lower left, and lower right zones). For this steering, we can use a superposition of prism shapes for radial and tangential steering as discussed above. This can achieve a desired deflection of 57 degrees. The superpositioned edges can be made rotationally symmetric about the axis of rotation with constant tangential and radial slopes to yield a helicoid with a sloped radius (which can be referred to as a “sloped helicoid”) as shown by 3300 of FIG. 33 (see also the sloped helicoids in FIGS. 36A-37D). For example, to steer light diagonally, we can use a superposition of the internal cross-section of a cone and a clockwise screw. Phase delay functions (4)(X,Y)) can be defined for different orientations of the sloped helicoid to achieve steering of light into a particular corner zone 120. For these examples, phase delay depends linearly on the (average) tangential distance R₀*t and radius. The helicoid shape 3300 can be represented by the phase delay function expression:

$$ϕ ( X , Y ) = \frac{2 π * ( {R}_{0} t + R )}{D} ; t = ( \frac{X}{Y} )$$

For metasurface phase delay as a function of X,Y, one can subtract n*2π, where n is an integer number to yield:

$$ϕ ( X , Y ) = 2 π * \{ \frac{sin θ * ( \pm {R}_{0} t * a tan ( \frac{X}{Y} ) \pm \sqrt{{X}^{2} + {Y}^{2}} )}{λ} \}$$

where the choice of whether to use addition or subtraction at the two locations where the plus/minus operator is shown will govern whether the steering goes to the upper right, upper left, lower right, or lower left zones.

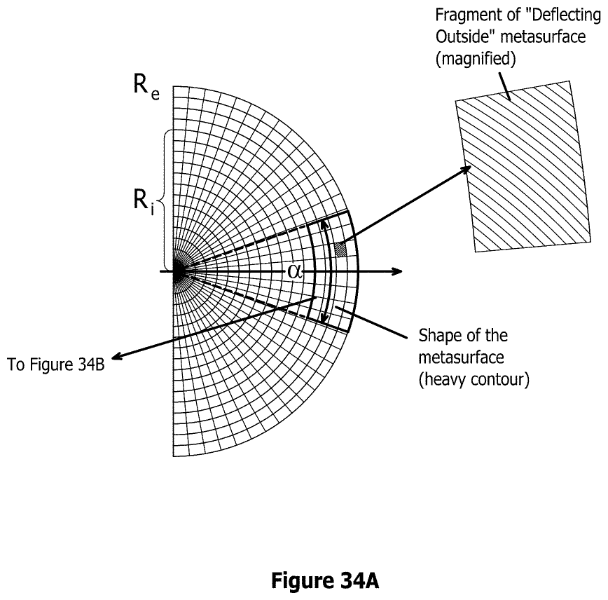

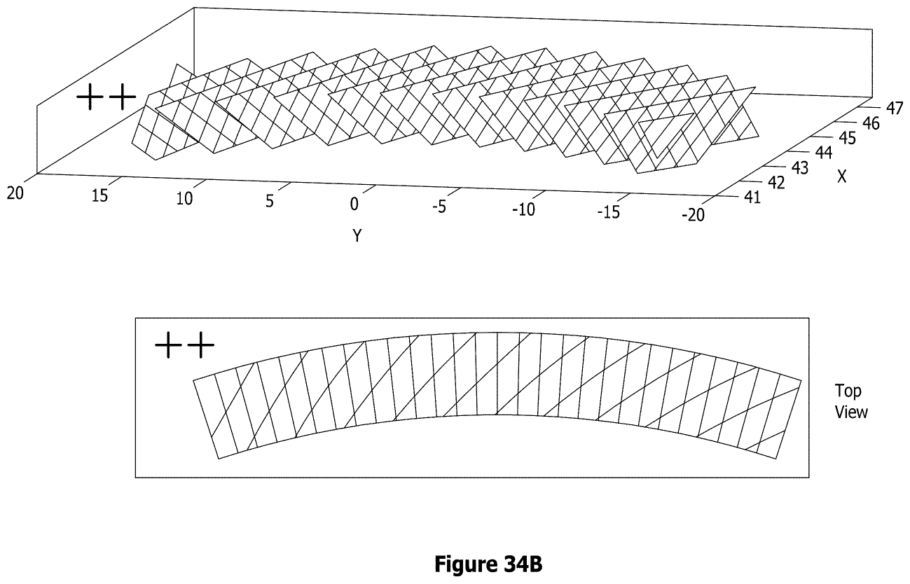

FIGS. 34A and 34B shows an example configuration for a metasurface that steers light into the upper left zone. It should be understood that the images of FIGS. 34A and 34B are not drawn to scale.

As an example, one can use approximate sizes such as Rₑ=50 mm, Rᵢ=45 mm, and α=40° (which is approximately 0.70 rad). Furthermore, consider the sloped helicoid surface equations:

X=R sin(t)

Y=R cos(t)

Z=R+C*t; (C=const)

One can then obtain:

$$C = \frac{2 π {R}_{0}}{D} = {R}_{0} sin θ \frac{2 π}{λ}$$

As shown by FIG. 34B, one can then subtract n*2π where n is an integer number to yield the configuration of:

$$ϕ ( X , Y ) = 2 π * \{ \frac{sin θ * ( {R}_{0} t * a tan ( \frac{X}{Y} ) + \sqrt{{X}^{2} + {Y}^{2}} )}{λ} \}$$

Accordingly, with this example, the expressions below show (1) a phase delay function for steering light to/from the upper right zone, (2) a phase delay function for steering light to/from the lower right zone, (3) a phase delay function for steering light to/from the lower left zone, and (4) a phase delay function for steering light to/from the upper left zone.

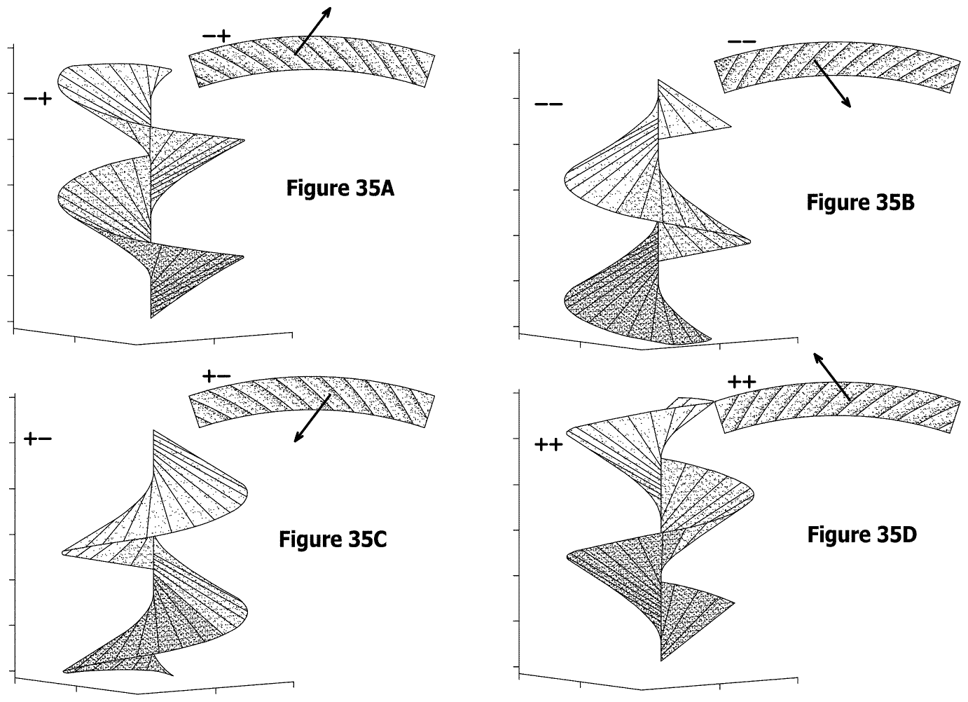

For upper right steering, the configuration defined by the following phase delay function is shown by FIGS. 35A, 36A, and 37A:

$$ϕ ( X , Y ) = 2 π * \{ \frac{sin θ * ( - {R}_{0} t * a tan ( \frac{X}{Y} ) + \sqrt{{X}^{2} + {Y}^{2}} )}{λ} \}$$

For lower right steering, the configuration defined by the following phase delay function is shown by FIGS. 35B, 36C, and 37C:

$$ϕ ( X , Y ) = 2 π * \{ \frac{sin θ * ( - {R}_{0} t * a tan ( \frac{X}{Y} ) - \sqrt{{X}^{2} + {Y}^{2}} )}{λ} \}$$

For lower left steering, the configuration defined by the following phase delay function is shown by FIGS. 35C, 36B, and 37B:

$$ϕ ( X , Y ) = 2 π * \{ \frac{sin θ * ( + {R}_{0} t * a tan ( \frac{X}{Y} ) - \sqrt{{X}^{2} + {Y}^{2}} )}{λ} \}$$

For upper left steering as discussed above, the configuration defined by the following phase delay function is shown by FIGS. 35D, 36D, and 37D (see also FIGS. 34A and 34B):

$$ϕ ( X , Y ) = 2 π * \{ \frac{sin θ * ( + {R}_{0} t * a tan ( \frac{X}{Y} ) + \sqrt{{X}^{2} + {Y}^{2}} )}{λ} \}$$

While FIGS. 25A-37D describe example configurations for metasurfaces that serve as light steering optical elements 130 on a carrier 104 for use in a flash lidar system to steer light to or from an example set of zones, it should be understood that practitioners may choose to employ different parameters for the metasurfaces to achieve different light steering patterns if desired.

Furthermore, for sufficiently large angles, a single prism would not suffice due to total internal reflection. However, techniques can be employed to increase the maximum deflection angle. For example, one can use two angled surfaces (with respect to the optical axis). As another example, one can use more than one prism such that the prisms are placed at a fixed separation (distance and angle) from each other. This could be applicable for both side and diagonal steerage. For example, a double prism can be made rotationally symmetric about the axis of rotation to yield a shape which provides a greater maximum deflection angle than could be achieved by a single prism that was made rotationally symmetric about the axis of rotation. Phase delay functions can then be defined for the rotationally symmetric double prism shape.

Furthermore, it should be understood that additional metasurfaces can be used in addition to the metasurfaces used for light steering. For example, a second metasurface can be positioned at a controlled spacing or distance from a first metasurface, where the first metasurface is used as a light steering optical element 130 while the second metasurface can be used as a diffuser, beam homogenizer, and/or beam shaper. For example, in instances where the rotating receiver prism or metasurface may cause excessive distortion of the image on the sensor 202, a secondary rotating (or counter-rotating) prism or metasurface ring (or a secondary static lens or metasurface) may be used to compensate for the distortion. Mechanical structures may be used to reduce stray light effects resulting from the receiver metasurface arrangement.

As yet another example, one or more of the light steering optical elements 130 can comprise a transmissive material that serves as beam steering slab in combination with a DOE that provides diffraction of the light steered by the beam steering slab (see FIG. 20D). Further still, the DOE can be positioned optically between the light source 102 and beam steering slab as indicated by FIG. 20E. As noted above, the DOEs of these examples may be adapted to provide beam shaping as well.

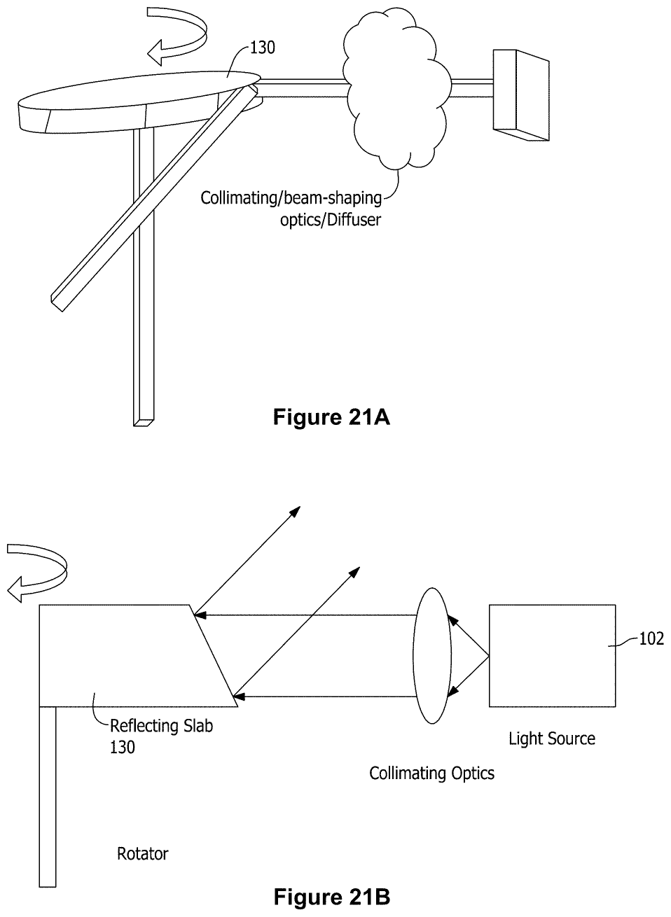

As yet another example, the light steering optical elements 130 can comprise reflective materials that provide steering of the optical signals 112 via reflections. Examples of such arrangements are shown by FIGS. 21A and 21B. Reflectors such as mirrors can be attached to or integrated into a rotating carrier 104 such as a wheel. The incident facets of the mirrors can be curved and/or tilted to provide desired steering of the incident optical signals 112 into the zones 120 corresponding to the reflectors.

Sensor 202:

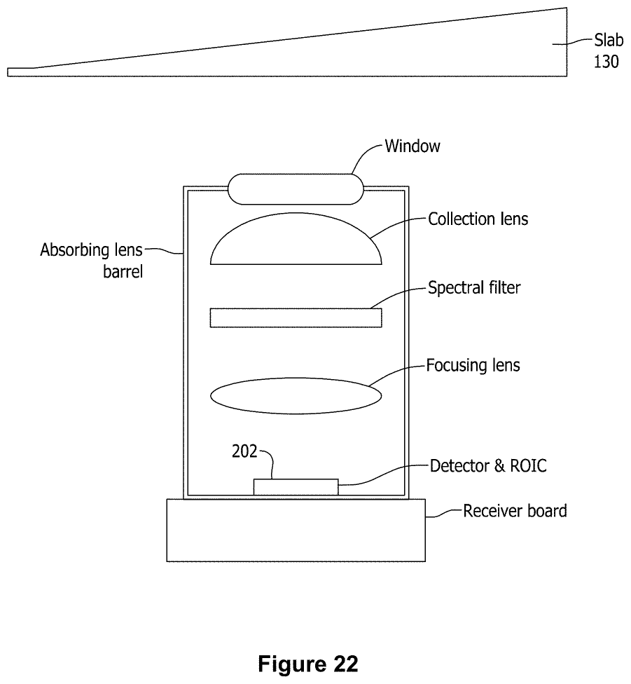

Sensor 202 can take the form of a photodetector array of pixels that generates signals indicative of the photons that are incident on the pixels. The sensor 202 can be enclosed in a barrel which receives incident light through an aperture and passes the incident light through receiver optics such as a collection lens, spectral filter, and focusing lens prior to reception by the photodetector array. An example of such a barrel architecture is shown by FIG. 22.

The barrel funnels the signal light (as well as an ambient light) passed through the window toward the sensor 202. The light propagating through the barrel passes through the collection lens, spectral filter, and focusing lens on its way to the sensor 202. The barrel may be of a constant diameter (cylindrical) or may change its diameter so as to enclose each optical element within it. The barrel can be made of a dark, non-reflective and/or absorptive material within the signal wavelength.

The collection lens is designed to collect light from the zone that corresponds to the aligned light steering optical element 130 after the light has been refracted toward it.

The collection lens can be, for example, either an h=f tan (Theta) or an h=f sin (Theta) or an h=f Theta lens. It may contain one or more elements, where the elements may be spherical or aspherical. The collection lens can be made of glass or plastic. The aperture area of the collection lens may be determined by its field of view, to conserve etendue, or it may be determined by the spectral filter diameter, so as to keep all elements inside the barrel the same diameter. The collection lens may be coated on its external edge or internal edge or both edges with anti-reflective coating.

The spectral filter may be, for example, an absorptive filter or a dielectric-stack filter. The spectral filter may be placed in the most collimated plane of the barrel in order to reduce the input angles. Also, the spectral filter may be placed behind a spatial filter in order to ensure the cone angle entering the spectral filter. The spectral filter may have a wavelength thermal-coefficient that is approximately matched to that of the light source 102 and may be thermally-coupled to the light source 102. The spectral filter may also have a cooler or heater thermally-coupled to it in order to limit its temperature-induced wavelength drift.

The focusing lens can then focus the light exiting the spectral filter onto the photodetector array (sensor 202).

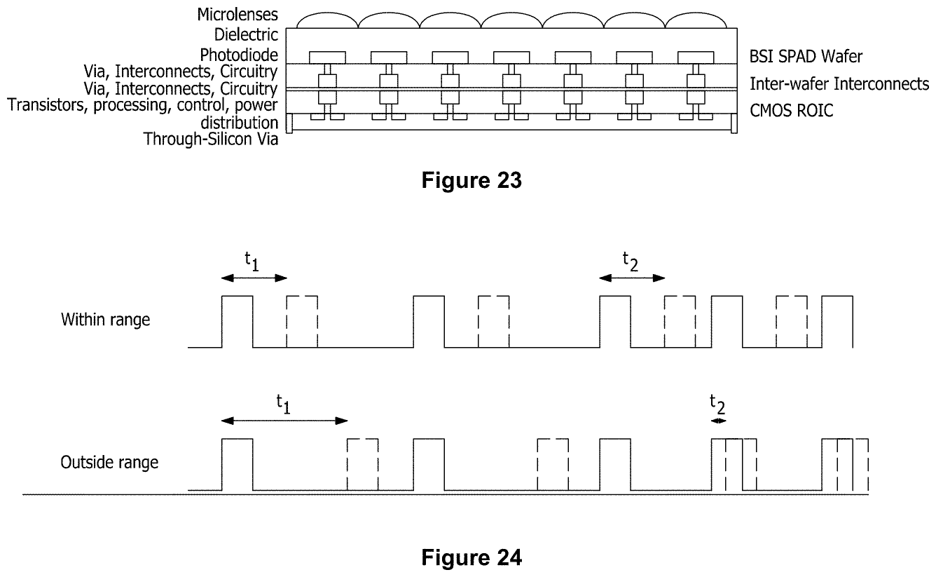

The photodetector array can comprise an array of single photon avalanche diodes (SPADs) that serve as the detection elements of the array. As another example, the photodetector array may comprise photon mixing devices that serve as the detection elements. Generally speaking, the photodetector array may comprise any sensing devices which can measure time-of-flight. Further still, the detector array may be front-side illuminated (FSI) or back-side illuminated (BSI), and it may employ microlenses to increase collection efficiency. Processing circuitry that reads out and processes the signals generated by the detector array may be in-pixel, on die, hybrid-bonded, on-board, or off-board, or any suitable combination thereof. An example architecture for sensor 202 is shown by FIG. 23.

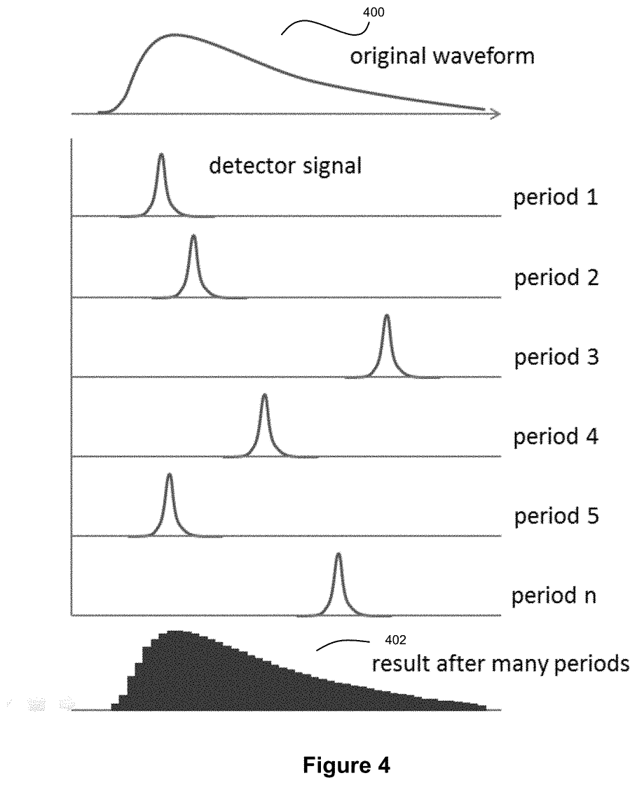

Returns can be detected within the signals 212 produced by the sensor 202 using techniques such as correlated photon counting. For example, time correlated single photon counting (TCSPC) can be employed. With this approach, a histogram is generated by accumulating photon arrivals within timing bins. This can be done on a per-pixel basis; however, it should be understood that a practitioner may also group pixels of the detector array together, in which case the counts from these pixels would be added up per bin. As shown by FIG. 4, a “true” histogram of times of arrival is shown at 400. In a TCSPC system, multiple laser pulses illuminate a target. Times of arrival (with reference to the emission time) are measured in response to each laser pulse. These are stored in memory bins which sum the counts (see 402 in FIG. 4). After a sufficiently large number of pulses has been fired, the histogram may be sufficiently reconstructed, and a peak detection algorithm may detect the position of the peak of the histogram. In an example embodiment, the resolution of the timing measurement may be determined by the convolution of the emitter pulse width, the detector's jitter, the timing circuit's precision, and the width of each memory time bin. In an example embodiment, improvements in timing measurement resolution may be attained algorithmically, e.g., via interpolation or cross-correlation with a known echo envelope.

As noted above, the zones 120 may have some overlap. For example, each zone 120 may comprise 60×60 degrees and have 5×60 degrees overlap with its neighbor. Post-processing can be employed that identifies common features in return data for the two neighboring zones for use in aligning the respective point clouds.

Control Circuitry:

For ease of illustration, FIGS. 1A and 2A show an example where the control circuitry includes a steering driver circuit 106 that operates to drive the rotation 110 of carrier 104. This driver circuit 106 can be a rotation actuator circuit that provides a signal to a motor or the like that drives the rotation 110 continuously at a constant rotational rate following a start-up initialization period and preceding a stopping/cool-down period. While a drive signal that produces a constant rotational rate may be desirable for some practitioners, it should be understood that other practitioners may choose to employ a variable drive signal that produces a variable/adjustable rotation rate to speed up or slow down the rotation 110 if desired (e.g., to increase or decrease the dwell time on certain zones 120).

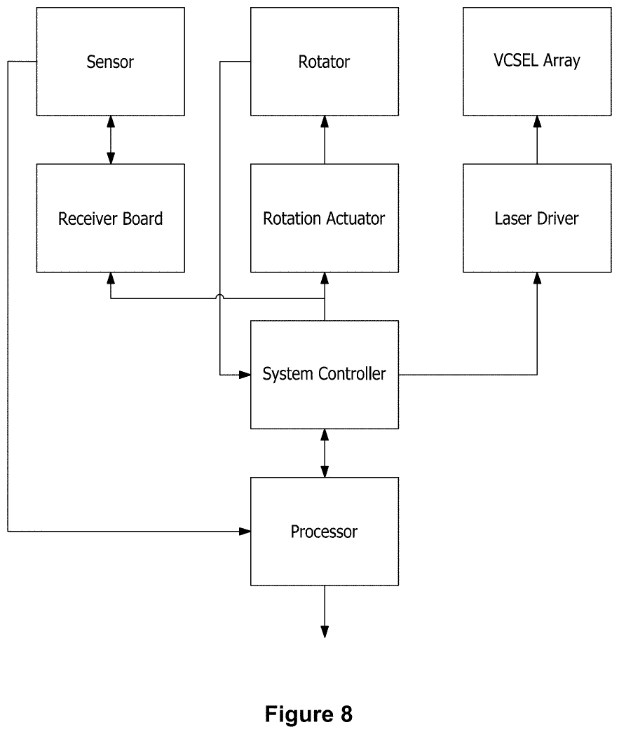

It should be understood that the lidar system 100 can employ additional control circuitry, such as the components shown by FIG. 8. For example, the system 100 can also include:
Receiver board circuitry that operates to bias and configure the detector array and its corresponding readout integrated circuit (ROIC) as well as transfer its output to the processor.
Laser driver circuitry that operates to pulse the emitter array (or parts of it) with timing and currents, ensuring proper signal integrity of fast slew rate high current signals.
System controller circuitry that operates to provide timing signals as well as configuration instructions to the various components of the system.
A processor that operates to generate the 3D point cloud, filter it from noise, and generate intensity spatial distributions which may be used by the system controller to increase or decrease emission intensities by the light source 102.

The receiver board, laser driver, and/or system controller may also include one or more processors that provide data processing capabilities for carrying out their operations. Examples of processors that can be included among the control circuitry include one or more general purpose processors (e.g., microprocessors) that execute software, one or more field programmable gate arrays (FPGAs), one or more application-specific integrated circuits (ASICs), or other compute resources capable of carrying out tasks described herein.

In an example embodiment, the light source 102 can be driven to produce relatively low power optical signals 112 at the beginning of each subframe (zone). If a return 210 is detected at sufficiently close range during this beginning time period, the system controller can conclude that an object is nearby, in which case the relatively low power is retained for the remainder of the subframe (zone) in order to reduce the risk of putting too much energy into the object. This can allow the system to operate as an eye-safe low power for short range objects. As another example, if the light source 102 is using collimated laser outputs, then the emitters that are illuminating the nearby object can be operated at the relatively low power during the remainder of the subframe (zone), while the other emitters have their power levels increased. If a return 210 is not detected at sufficiently close range or sufficiently high intensity during this beginning time period, then the system controller can instruct the laser driver to increase the output power for the optical signals 112 for the remainder of the subframe. Such modes of operation can be referred to as providing a virtual dome for eye safety. Furthermore, it should be understood that such modes of operation provide for adaptive illumination capabilities where the system can adaptively control the optical power delivered to regions within a given zone such that some regions within a given zone can be illuminated with more light than other regions within that given zone.

The control circuitry can also employ range disambiguation to reduce the risk of conflating or otherwise mis-identifying returns 210. An example of this is shown by FIG. 24. A nominal pulse repetition rate can be determined by a maximum range for the system (e.g., 417 ns or more for a system with a maximum range of 50 meters). The system can operate in 2 close pulse periods, either interleaved or in bursts. Targets appearing at 2 different ranges are either rejected or measured at their true range as shown by FIG. 24.

In another example, the control circuitry can employ interference mitigation to reduce the risk of mis-detecting interference as returns 210. For example, as noted, the returns 210 can be correlated with the optical signals 112 to facilitate discrimination of returns 210 from non-correlated light that may be incident on sensor 202. As an example, the system can use correlated photon counting to generate histograms for return detection.

The system controller can also command the rotator actuator to rotate the carrier 104 to a specific position (and then stop the rotation) if it is desired to perform single zone imaging for an extended time period. Further still, the system controller can reduce the rotation speed created by the rotation actuator if low power operation is desired at a lower frame rate (e.g., more laser cycles per zone). As another example, the rotation speed can be slowed by n by repeating the zone cycle n times and increasing the radius n times. For example, for 9 zones at 30 frames per second (fps), the system can use 27 light steering optical elements 130 around the carrier 104, and the carrier 104 can be rotated at 10 Hz.

As examples of sizes for example embodiments of a lidar system as described herein that employs rotating light steering optical elements 130 and 9 zones in the field of view, the size of the system will be significantly affected by the values for X and Y in the ring diameter for a doughnut or other similar form for carrying the light steering optical elements 130. We can assume that a 5 mm×5 mm emitter array can be focused to 3 mm×3 mm by increasing beam divergence by 5/3. We can also assume for purposes of this example that 10% of time can be sacrificed in transitions between light steering optical elements 130. Each arc for a light steering optical element 130 can be 3 mm×10 (or 30 mm in perimeter), which yields a total perimeter of 9×30 mm (270 mm). The diameter for the carrier of the light steering optical elements can thus be approximately 270/3.14 (86 mm). Moreover, depth can be constrained by cabling and lens focal length, which we can assume at around 5 cm.

Spatial-Stepping Through Zones for Scanning Lidar Systems:

The spatial stepping techniques discussed above can be used with lidar systems other than flash lidar if desired by a practitioner. For example, the spatial stepping techniques can be combined with scanning lidar systems that employ point illumination rather than flash illumination. With this approach, the aligned light steering optical elements 130 will define the zone 120 within which a scanning lidar transmitter directs its laser pulse shots over a scan pattern (and the zone 120 from which the lidar receiver will detect returns from these shots).

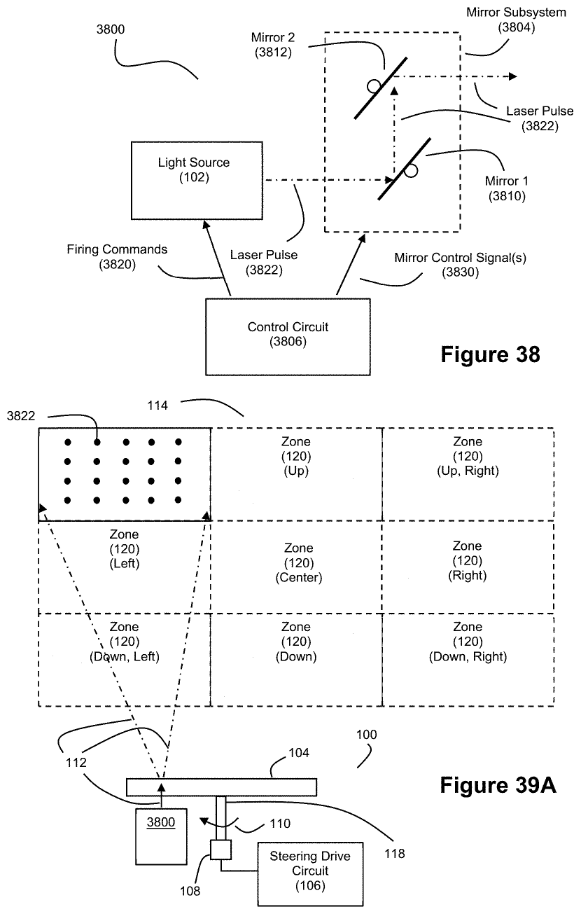

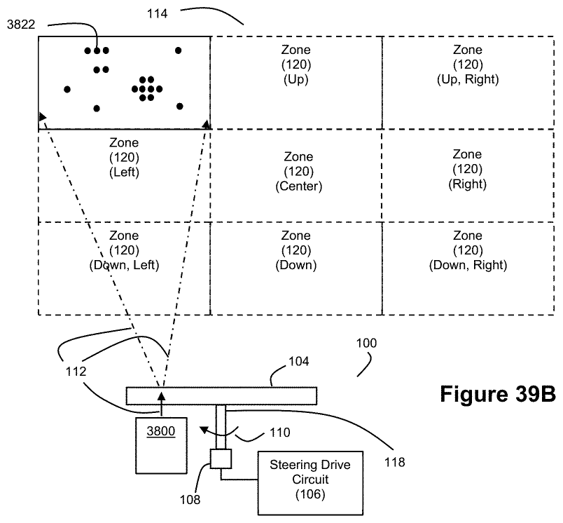

FIG. 38 depicts an example scanning lidar transmitter 3800 that can be used as the transmission system in combination with the light steering optical elements 130 discussed above. FIGS. 39A and 39B show examples of lidar systems 100 that employ spatial stepping via carrier 104 using a scanning lidar transmitter 3800.

The example scanning lidar transmitter 3800 shown by FIG. 38 uses a mirror subsystem 3804 to direct laser pulses 3822 from the light source 102 toward range points in the field of view. These laser pulses 3822 can be referred to as laser pulse shots (or just “shots”), where these shots are fired by the scanning lidar transmitter 3800 to provide scanned point illumination for the system 100. The mirror subsystem 3804 can comprise a first mirror 3810 that is scannable along a first axis (e.g., an X-axis or azimuth) and a second mirror 3812 that is scannable along a second axis (e.g., a Y-axis or elevation) to define where the transmitter 3800 will direct its shots 3822 in the field of view.

The light source 102 fires laser pulses 3822 in response to firing commands 3820 received from the control circuit 3806. In the example of FIG. 38, the light source 102 can use optical amplification to generate the laser pulses 3822. In this regard, the light source 102 that includes an optical amplifier can be referred to as an optical amplification laser source. The optical amplification laser source may comprise a seed laser, an optical amplifier, and a pump laser. As an example, the light source 102 can be a pulsed fiber laser. However, it should be understood that other types of lasers could be used as the light source 102 if desired by a practitioner.

The mirror subsystem 3804 includes a mirror that is scannable to control where the lidar transmitter 3800 is aimed. In the example embodiment of FIG. 38, the mirror subsystem 3804 includes two scan mirrors—mirror 3810 and mirror 3812. Mirrors 3810 and 3812 can take the form of MEMS mirrors. However, it should be understood that a practitioner may choose to employ different types of scannable mirrors. Mirror 3810 is positioned optically downstream from the light source 102 and optically upstream from mirror 3812. In this fashion, a laser pulse 3822 generated by the light source 102 will impact mirror 3810, whereupon mirror 3810 will reflect the pulse 3822 onto mirror 3812, whereupon mirror 3812 will reflect the pulse 3822 for transmission into the environment (FOV). It should be understood that the outgoing pulse 3822 may pass through various transmission optics during its propagation from mirrors 3810 and 3812 into the environment.

In the example of FIG. 38, mirror 3810 can scan through a plurality of mirror scan angles to define where the lidar transmitter 3800 is targeted along a first axis. This first axis can be an X-axis so that mirror 3810 scans between azimuths. Mirror 3812 can scan through a plurality of mirror scan angles to define where the lidar transmitter 3800 is targeted along a second axis. The second axis can be orthogonal to the first axis, in which case the second axis can be a Y-axis so that mirror 3812 scans between elevations. The combination of mirror scan angles for mirror 3810 and mirror 3812 will define a particular {azimuth, elevation} coordinate to which the lidar transmitter 3800 is targeted. These azimuth, elevation pairs can be characterized as {azimuth angles, elevation angles} and/or {rows, columns} that define range points in the field of view which can be targeted with laser pulses 3822 by the lidar transmitter 3800. While this example embodiment has mirror 3810 scanning along the X-axis and mirror 3812 scanning along the Y-axis, it should be understood that this can be flipped if desired by a practitioner.

A practitioner may choose to control the scanning of mirrors 3810 and 3812 using any of a number of scanning techniques to achieve any of a number of shot patterns.

For example, mirrors 3810 and 3812 can be controlled to scan line by line through the field of view in a grid pattern, where the control circuit 3806 provides firing commands 3820 to the light source 102 to achieve a grid pattern of shots 3822 as shown by the example of FIG. 39A. With this approach, as carrier 104 moves (e.g., rotates) and a given light steering optical element 130 becomes aligned with the light source 102, the transmitter 3800 will exercise its scan pattern within one of the zones 120 as shown by FIG. 39A (e.g., the upper left zone 120). The transmitter 3800 can then fire shots 3822 in a shot pattern within this zone 120 that achieves a grid pattern as shown by FIG. 39A.

As another example, in a particularly powerful embodiment, mirror 110 can be driven in a resonant mode according to a sinusoidal signal while mirror 112 is driven in a point-to-point mode according to a step signal that varies as a function of the range points to be targeted with laser pulses 3822 by the lidar transmitter 100. This agile scan approach can yield a shot pattern for intelligently selected laser pulse shots 3822 as shown by FIG. 39B where shots 3822 are fired at points of interest within the relevant zone 120 (rather than a full grid as shown by FIG. 39A). Example embodiments for intelligent agile scanning and corresponding mirror scan control techniques for the scanning lidar transmitter 3800 are described in greater detail in U.S. Pat. Nos. 10,078,133, 10,641,897, 10,642,029, 10,656,252, 11,002,857, and 11,442,152, U.S. Patent App. Pub. Nos. 2022/0308171 and 2022/0308215, and U.S. patent application Ser. No. 17/554,212, filed Dec. 17, 2021, and entitled “Hyper Temporal Lidar with Controllable Tilt Amplitude for a Variable Amplitude Scan Mirror”, the entire disclosures of each of which are incorporated herein by reference.

For example, the control circuit 3806 can intelligently select which range points in the relevant zone 120 should be targeted with laser pulse shots (e.g., based on an analysis of a scene that includes the relevant zone 120 so that salient points are selected for targeting—such as points in high contrast areas, points near edges of objects in the field, etc.; based on an analysis of the scene so that particular software-defined shot patterns are selected (e.g., foveation shot patterns, etc.)). The control circuit 3806 can then generate a shot list of these intelligently selected range points that defines how the mirror subsystem will scan and the shot pattern that will be achieved. The shot list can thus serve as an ordered listing of range points (e.g., scan angles for mirrors 3810 and 3812) to be targeted with laser pulse shots 3822. Mirror 3810 can be operated as a fast-axis mirror while mirror 3812 is operated as a slow-axis mirror. When operating in such a resonant mode, mirror 3810 scans through scan angles in a sinusoidal pattern. In an example embodiment, mirror 3810 can be scanned at a frequency in a range between around 100 Hz and around 20 kHz. In a preferred embodiment, mirror 3810 can be scanned at a frequency in a range between around 10 kHz and around 15 kHz (e.g., around 12 kHz). As noted above, mirror 3812 can be driven in a point-to-point mode according to a step signal that varies as a function of the range points on the shot list. Thus, if the lidar transmitter 3800 is to fire a laser pulse 3822 at a particular range point having an elevation of X, then the step signal can drive mirror 3812 to scan to the elevation of X. When the lidar transmitter 3800 is later to fire a laser pulse 3822 at a particular range point having an elevation of Y, then the step signal can drive mirror 3812 to scan to the elevation of Y. In this fashion, the mirror subsystem 3804 can selectively target range points that are identified for targeting with laser pulses 3822. It is expected that mirror 3812 will scan to new elevations at a much slower rate than mirror 3810 will scan to new azimuths. As such, mirror 3810 may scan back and forth at a particular elevation (e.g., left-to-right, right-to-left, and so on) several times before mirror 3812 scans to a new elevation. Thus, while the mirror 112 is targeting a particular elevation angle, the lidar transmitter 100 may fire a number of laser pulses 3822 that target different azimuths at that elevation while mirror 110 is scanning through different azimuth angles. Because of the intelligent selection of range points for targeting with the shots 3822, it should be understood that the scan pattern exhibited by the mirror subsystem 3804 may include a number of line repeats, line skips, interline skips, and/or interline detours as a function of the ordered scan angles for the shots on the shot list.

Control circuit 3806 is arranged to coordinate the operation of the light source 3802 and mirror subsystem 3804 so that laser pulses 3822 are transmitted in a desired fashion. In this regard, the control circuit 3806 coordinates the firing commands 3820 provided to light source 3802 with the mirror control signal(s) 3830 provided to the mirror subsystem 3804. In the example of FIG. 38, where the mirror subsystem 3804 includes mirror 3810 and mirror 3812, the mirror control signal(s) 3830 can include a first control signal that drives the scanning of mirror 3810 and a second control signal that drives the scanning of mirror 3812. Any of the mirror scan techniques discussed above can be used to control mirrors 3810 and 3812. For example, mirror 3810 can be driven with a sinusoidal signal to scan mirror 3810 in a resonant mode, and mirror 3812 can be driven with a step signal that varies as a function of the range points to be targeted with laser pulses 3822 to scan mirror 3812 in a point-to-point mode.

As discussed in the above-referenced and incorporated U.S. Pat. No. 11,442,152 and U.S. Patent App. Pub. No. 2022/0308171, control circuit 3806 can use a laser energy model to schedule the laser pulse shots 3822 to be fired toward targeted range points. This laser energy model can model the available energy within the laser source 102 for producing laser pulses 3822 over time in different shot schedule scenarios. For example, the laser energy model can model the energy retained in the light source 102 after shots 3822 and quantitatively predict the available energy amounts for future shots 3822 based on prior history of laser pulse shots 3822. These predictions can be made over short time intervals—such as time intervals in a range from 10-100 nanoseconds. By modeling laser energy in this fashion, the laser energy model helps the control circuit 3806 make decisions on when the light source 102 should be triggered to fire laser pulses 3822.

Control circuit 3806 can include a processor that provides the decision-making functionality described herein. Such a processor can take the form of a field programmable gate array (FPGA) or application-specific integrated circuit (ASIC) which provides parallelized hardware logic for implementing such decision-making. The FPGA and/or ASIC (or other compute resource(s)) can be included as part of a system on a chip (SoC). However, it should be understood that other architectures for control circuit 3806 could be used, including software-based decision-making and/or hybrid architectures which employ both software-based and hardware-based decision-making. The processing logic implemented by the control circuit 3806 can be defined by machine-readable code that is resident on a non-transitory machine-readable storage medium such as memory within or available to the control circuit 3806. The code can take the form of software or firmware that define the processing operations discussed herein for the control circuit 3806.

As the lidar system of 100 of FIGS. 39A and 39B operates, the system will spatially step through the zones 120 within which the transmitter 3800 scans and fires its shots 3822 based on which light steering optical elements 130 are aligned with the transmission aperture of the transmitter 3800. Any of the types of light steering optical elements 130 discussed above for flash lidar system embodiments can be used with the example embodiments of FIGS. 39A and 39B. Moreover, any of the spatial stepping techniques discussed above for flash lidar systems can be employed with the example embodiments of FIGS. 39A and 39B.

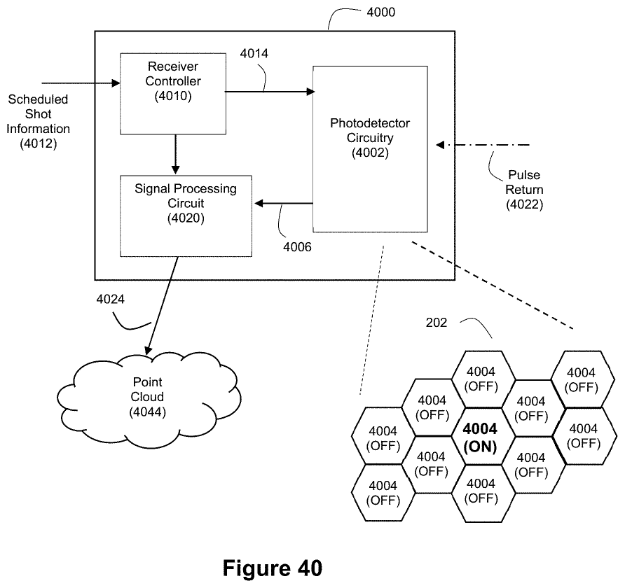

Furthermore, the lidar systems 100 of FIGS. 39A and 39B can employ a lidar receiver 4000 such as that shown by FIG. 40 to detect returns from the shots 3822.

The lidar receiver 4000 comprises photodetector circuitry 4002 which includes the sensor 202, where sensor 202 can take the form of a photodetector array. The photodetector array comprises a plurality of detector pixels 4004 that sense incident light and produce a signal representative of the sensed incident light. The detector pixels 4004 can be organized in the photodetector array in any of a number of patterns. In some example embodiments, the photodetector array can be a two-dimensional (2D) array of detector pixels 4004. However, it should be understood that other example embodiments may employ a one-dimensional (1D) array of detector pixels 4004 (or 2 differently oriented 1D arrays of pixels 4004) if desired by a practitioner.

The photodetector circuitry 4002 generates a return signal 4006 in response to a pulse return 4022 that is incident on the photodetector array. The choice of which detector pixels 4004 to use for collecting a return signal 4006 corresponding to a given return 4022 can be made based on where the laser pulse shot 3822 corresponding to the return 4022 was targeted. Thus, if a laser pulse shot 3822 is targeting a range point located at a particular azimuth angle, elevation angle pair; then the lidar receiver 4000 can map that azimuth, elevation angle pair to a set of pixels 4004 within the sensor 202 that will be used to detect the return 4022 from that laser pulse shot 3822. The azimuth, elevation angle pair can be provided as part of scheduled shot information 4012 that is communicated to the lidar receiver 4000. The mapped pixel set can include one or more of the detector pixels 4004. This pixel set can then be activated and read out from to support detection of the subject return 4022 (while the pixels 4004 outside the pixel set are deactivated so as to minimize potential obscuration of the return 4022 within the return signal 4006 by ambient or interfering light that is not part of the return 4022 but would be part of the return signal 4006 if unnecessary pixels 4004 were activated when return 4022 was incident on sensor 202). In this fashion, the lidar receiver 4000 will select different pixel sets of the sensor 202 for readout in a sequenced pattern that follows the sequenced spatial pattern of the laser pulse shots 3822. Return signals 4006 can be read out from the selected pixel sets, and these return signals 4006 can be processed to detect returns 4022 therewithin.

FIG. 40 shows an example where one of the pixels 4004 is turned on to start collection of a sensed signal that represents incident light on that pixel (to support detection of a return 4022 within the collected signal), while the other pixels 4004 are turned off (or at least not selected for readout). While the example of FIG. 40 shows a single pixel 4004 being included in the pixel set selected for readout, it should be understood that a practitioner may prefer that multiple pixels 4004 be included in one or more of the selected pixel sets. For example, it may be desirable to include in the selected pixel set one or more pixels 4004 that are adjacent to the pixel 4004 where the return 4022 is expected to strike.

Examples of circuitry and control logic that can used for this selective pixel set readout are described in U.S. Pat. Nos. 9,933,513, 10,386,467, 10,663,596, and 10,743,015, U.S. Patent App. Pub. No. 2022/0308215, and U.S. patent application Ser. No. 17/490,265, filed Sep. 30, 2021, entitled “Hyper Temporal Lidar with Multi-Processor Return Detection” and U.S. patent application Ser. No. 17/554,212, filed Dec. 17, 2021, entitled “Hyper Temporal Lidar with Controllable Tilt Amplitude for a Variable Amplitude Scan Mirror”, the entire disclosures of each of which are incorporated herein by reference. These incorporated patents and patent applications also describe example embodiments for the photodetector circuitry 4002, including the use of a multiplexer to selectively read out signals from desired pixel sets as well as an amplifier stage positioned between the sensor 202 and multiplexer.

Signal processing circuit 4020 operates on the return signal 4006 to compute return information 4024 for the targeted range points, where the return information 4024 is added to the lidar point cloud 4044. The return information 4024 may include, for example, data that represents a range to the targeted range point, an intensity corresponding to the targeted range point, an angle to the targeted range point, etc. As described in the above-referenced and incorporated U.S. Pat. Nos. 9,933,513, 10,386,467, 10,663,596, and 10,743,015, U.S. Patent App. Pub. No. 2022/0308215, and U.S. patent application Ser. Nos. 17/490,265 and 17/554,212, the signal processing circuit 4020 can include an analog-to-digital converter (ADC) that converts the return signal 4006 into a plurality of digital samples. The signal processing circuit 4020 can process these digital samples to detect the returns 4022 and compute the return information 4024 corresponding to the returns 4022. In an example embodiment, the signal processing circuit 4020 can perform time of flight (TOF) measurement to compute range information for the returns 4022. However, if desired by a practitioner, the signal processing circuit 4020 could employ time-to-digital conversion (TDC) to compute the range information.

The lidar receiver 4000 can also include circuitry that can serve as part of a control circuit for the lidar system 100. This control circuitry is shown as a receiver controller 4010 in FIG. 40. The receiver controller 4010 can process scheduled shot information 4012 to generate the control data 4014 that defines which pixel set to select (and when to use each pixel set) for detecting returns 4022. The scheduled shot information 4012 can include shot data information that identifies timing and target coordinates for the laser pulse shots 3822 to be fired by the lidar transmitter 3800. In an example embodiment, the scheduled shot information 4012 can also include detection range values to use for each scheduled shot to support the detection of returns 4022 from those scheduled shots. These detection range values can be translated by the receiver controller 4010 into times for starting and stopping collections from the selected pixels 4004 of the sensor 202 with respect to each return 4022.

The receiver controller 4010 and/or signal processing circuit 4020 may include one or more processors. These one or more processors may take any of a number of forms. For example, the processor(s) may comprise one or more microprocessors. The processor(s) may also comprise one or more multi-core processors. As another example, the one or more processors can take the form of a field programmable gate array (FPGA) or application-specific integrated circuit (ASIC) which provide parallelized hardware logic for implementing their respective operations. The FPGA and/or ASIC (or other compute resource(s)) can be included as part of a system on a chip (SoC). However, it should be understood that other architectures for such processor(s) could be used, including software-based decision-making and/or hybrid architectures which employ both software-based and hardware-based decision-making. The processing logic implemented by the receiver controller 4010 and/or signal processing circuit 4020 can be defined by machine-readable code that is resident on a non-transitory machine-readable storage medium such as memory within or available to the receiver controller 4010 and/or signal processing circuit 4020. The code can take the form of software or firmware that define the processing operations discussed herein.

In operation, the lidar system 100 of FIGS. 39A and 39B operating in the point illumination mode can use lidar transmitter 3800 to fire one shot 3822 at a time to targeted range points within the aligned zone 120 and process samples from a corresponding detection interval for each shot 3822 to detect returns from such single shots 3822. As the lidar system 100 spatially steps through each zone 120, the lidar transmitter 3800 and lidar receiver 4000 can fire shots 3822 at targeted range points in each zone 120 and detect the returns 4022 from these shots 3822.

Spatial-Stepping Through Zones for Non-Lidar Imaging Systems:

The spatial stepping techniques discussed above can be used with imaging systems that need not use lidar if desired by a practitioner. For example, there are many applications where a FOV needs to be imaged under a variety of ambient lighting conditions where signal acquisition would benefit from better illumination of the FOV. Examples of such imaging applications include but are not limited to imaging systems that employ active illumination, such as security imaging (e.g., where a perimeter, boundary, and/or border needs to be imaged under diverse lighting conditions such as day and night), microscopy (e.g., fluorescence microscopy), and hyperspectral imaging.

With the spatial stepping techniques described herein, the discrete changes in zonal illumination/acquisition even while the carrier is continuously moving allows for a receiver to minimize the number of readouts, particularly for embodiments that employ a CMOS sensor such as a CMOS active pixel sensor (APS) or CMOS image sensor (CIS). Since the zone of illumination will change on a discrete basis with relatively long dwell times per zone (as compared to a continuously scanned illumination approach), the photodetector pixels will be imaging the same solid angle of illumination for the duration of an integration for a given zone. This stands in contrast to non-CMOS scanning imaging modalities such as time delay integration (TDI) imagers which are based on Charge-Coupled Devices (CCDs). With TDI imagers, the field of view is scanned with illuminating light continuously (as opposed to discrete zonal illumination), and this requires precise synchronization of the charge transfer rate of the CCD with the mechanical scanning of the imaged objects. Furthermore, TDI imagers require a linear scan of the object along the same axis as the TDI imager. With the zonal illumination/acquisition approach for example embodiments described herein, imaging systems are able to use less expensive CMOS pixels with significantly reduced read noise penalties and without requiring fine mechanical alignments with respect to scanning.

Thus, if desired by a practitioner, a system 100 as discussed above in connection with, for example, FIGS. 1A and 2A, for use in lidar applications can instead be an imaging system 100 that serves as an active illumination camera system for use in fields such use in a field such as security (e.g., imaging a perimeter, boundary, border, etc.). As another example, the imaging system 100 as shown by FIGS. 1A and 2A can be for a microscopy application such as fluorescence microscopy. As yet another example, the imaging system 100 as shown by FIGS. 1A and 2A can be used for hyperspectral imaging (e.g., hyperspectral imaging using etalons or Fabry-Perot interferometers). It should also be understood that the imaging system 100 can still be employed for other imaging uses cases.

With example embodiments for active illumination imaging systems 100 that employ spatial stepping, it should be understood that the light source 102 need not be a laser. For example, the light source 102 can be a light emitting diode (LED) or other type of light source so long as the light it produces can be sufficiently illuminated by appropriate optics (e.g., a collimating lens or a microlens array) before entering a light steering optical element 130. It should also be understood that the design parameters for the receiver should be selected so that photodetection exhibits sufficient sensitivity in the emitter's emission/illumination band and the spectral filter (if used) will have sufficient transmissivity in that band.

With example embodiments for active illumination imaging systems 100 that employ spatial stepping, it should also be understood that the sensor 202 may be a photodetector array that comprises an array of CMOS image sensor pixels (e.g., ASP or CIS pixels), CCD pixels, or other photoelectric devices which convert optical energy into an electrical signal, directly or indirectly. Furthermore, the signals generated by the sensor 202 may be indicative of the number and/or wavelength of the incident photons. In an example embodiment, the pixels may have a spectral or color filter deposited on them in a pattern such as a mosaic pattern, e.g., RGGB (red green blue) so that the pixels provide some spectral information regarding the detected photons.

Furthermore, in an example embodiment, the spectral filter used in the receiver architecture for the active illumination imaging system 100 may be placed or deposited directly on the photodetector array; or the spectral filter may comprise an array of filters (such as RGGB filters).

In another example embodiment for the active illumination imaging system 100, the light steering optical elements 130 may incorporate a spectral filter. For example, in an example embodiment with fluorescence microscopy, the spectral filter of a light steering optical element 130 may be centered on a fluorescence emission peak of one or more fluorophores for the system. Moreover, with an example embodiment, more than one light steering optical element 130 may be used to illuminate and image a specific zone (or a first light steering optical element 130 may be used for the emitter while a second light steering optical element 130 may be used for the receiver). Each of the light steering optical elements 130 that correspond to the same zone may be coated with a different spectral filter corresponding to a different spectral band. As an example, continuing with the fluorescence microscopy use case, the system may illuminate the bottom right of the field with a single light steering optical element 130 for a time period (e.g., 100 msec) at 532 nm, while the system acquires images from that zone using a first light steering optical element 130 containing a first spectral filter (e.g., a 20 nm-wide 560 nm-centered spectral filter) for a first portion of the relevant time period (e.g., the first 60 msec) and then with a second light steering optical element 130 containing a second spectral filter (e.g., a 30 nm-wide 600 nm-centered spectral filter) for the remaining portion of the relevant time period (e.g., the next 40 msec), where these two spectral filters correspond to the emissions of two fluorophone species in the subject zone.

As noted above, the imaging techniques described herein can be employed with security cameras. For example, security cameras may be used for perimeter or border security, and a large FoV may need to be imaged day and night at high resolution. In such a scenario, it can be expected that the information content will be very sparse (objects of interest will rarely appear, and will appear in a small portion of the field of view if present). An active illumination camera that employs imaging techniques described herein with spatial stepping could be mounted in a place where it can image and see the desired FOV.

For an example embodiment, consider a large FoV that is to be imaged day and night with fine resolution. For example, a field of view of 160 degree horizontal by 80 degrees vertical may need to be imaged such that a person 1.50 m tall is imaged by 6 pixels while 500 m away. At 500 m, 1.50 m subtends arctan (1.5/500)=0.17 degrees. This means that each pixel in the sensor needs to image 0.028×0.028 degrees and that a sufficient illumination power must be emitted to generate a sufficiently high SNR in the receiver that overcomes electrical noise in the receiver. With a traditional non-scanning camera, we would need an image sensor with (160×80)/(0.028×0.028)=5,700×2,900 pixels, i.e., 16 MPixels, in which case a very expensive camera would be needed to support this field of view and resolution. Mechanically scanning cameras which would try to scan this FoV with this resolution would be slow, and the time between revisits of the same angular position would be too long, in which case critical images may be lost. A mechanically scanning camera would also be able to only image one zone at a given time, before it slowly moves to the other location. Moreover, the illumination area required to illuminate a small, low-reflective object, for example at night, if illuminating the whole FoV, would be very high, resulting in high power consumption, high cost, and high heat dissipation. However, the architecture described herein can image with the desired parameters at much lower cost. For example, using the architecture described herein, we may use 9 light steering optical elements, each corresponding to a zone of illumination and acquisition of 55 degrees horizontal x 30 degrees horizontal. This provides 1.7×3.5 degree overlap between zones. The image sensor for this example needs only (55×30)/(0.028×0.028)=2,000×1,000 pixels=2 Mpixels; and the required optics would be small and introduce less distortion. In cases where the dominant noise source is proportional to the integration time (e.g., sensor dark noise), the required emitter power would be reduced by sqrt(9)=3, because each integration is 9 times shorter than that of a full field system. Each point in the field of view will be imaged at the same frame rate as with the original single-FoV camera.

Furthermore, as noted above, the imaging techniques described herein can be employed with microscopy, such as active illumination microscopy (e.g., fluorescence microscopy). In some microscopy applications there is a desire to reduce the excitation filter's total power and there is also a desire to achieve maximal imaging resolution without using very large lenses or focal plane arrays. Furthermore, there is sometimes a need to complete an acquisition of a large field of view in a short period of time, e.g., to achieve screening throughput or to prevent degradation to a sample. Imaging techniques like those described herein can be employed to improve performance. For example, a collimated light source can be transmitted through a rotating slab ring which steers the light to discrete FOIs via the light steering optical elements 130. A synchronized ring then diverts the light back to the sensor 202 through a lens, thus reducing the area of the sensor's FPA. The assumption is that regions which are not illuminated contribute negligible signal (e.g., there is negligible autofluorescence) and that the system operates with a sufficiently high numerical aperture such that the collimation assumption for the returned light still holds. In microscopy, some of the FPA's are very expensive (e.g., cooled scientific CCD cameras with single-photon sensitivity or high-sensitivity single-photon sensors for fluorescence lifetime imaging (FLIM) of fluorescence correlation spectroscopy (FCS), and it is desirable to reduce the number of pixels in the FPA array in order to reduce the cost of these systems.

As yet another example, the imaging techniques described herein can also be employed with hyperspectral imaging. For example, these imaging techniques can be applied to hyperspectral imaging using etalons or Fabry-Perot interferometers (e.g., see U.S. Pat. No. 10,012,542). In these systems, a cavity (which may be a tunable cavity) is formed between two mirrors, and the cavity only transmits light for which its wavelength obeys certain conditions (e.g., the integer number of wavelengths match a round trip time in the cavity). It is often desirable to construct high-Q systems, i.e., with very sharp transmission peaks and often with high finesse. These types of structures may also be deposited on top of image sensor pixels to achieve spectral selectivity. The main limitation of such systems is light-throughput or Etendue. In order to achieve high-finesse Fabry-Perot imaging, the incoming light must be made collimated, and in order to conserve Etendue, the aperture of the conventional FPI (Fabry-Perot Interferometer) must increase. A compromise is typically made whereby the FoV of these systems is made small (for example, by placing them very far, such as meters, from the imaged objects, which results in less light collected and lower resolution). This can be addressed by flooding the scene with very high power light, but this results in higher-power and more expensive systems. Accordingly, the imaging techniques described herein which employ spatial stepping can be used to maintain a larger FOV for hyperspectral imaging applications such as FPIs.

With the rotating light steering optical elements 130 as described herein, the directional (partially collimated) illumination light can be passed through the rotating light steering optical elements 130, thereby illuminating one zone 120 at a time, and for a sufficient amount of time for the hyperspectral camera to collect sufficient light through its cavity. A second ring with a sufficiently large aperture steers the reflected light to the FPI. Thus, the field-of-view into the FPI is reduced (e.g., by 9×) and this results either in a 9× decrease in its aperture area, and therefore in its cost (or an increase in its yield). If it is a tunable FPI, then the actuators which scan the separation between its mirrors would need to actuate a smaller mass, making them less expensive and less susceptible to vibration at low frequencies. Note that while the size of the FPI is reduced, the illumination power is not reduced because for 9× smaller field, we have 9× shorter time to deliver the energy, so the required power is the same. In cases where the noise source is proportional to the acquisition time (e.g., in SWIR or mid infrared (MIR) hyperspectral imaging, such as for gas detection), we do get a reduction in illumination power because the noise would scale down with the square root of the integration time.

While the invention has been described above in relation to its example embodiments, various modifications may be made thereto that still fall within the invention's scope. These and other modifications to the invention will be recognizable upon review of the teachings herein.

What is claimed is:

1. A lidar system comprising:
an optical emitter that emits optical signals into a field of view, wherein the field of view comprises a plurality of zones;
an optical sensor that senses optical returns of a plurality of the emitted optical signals from the field of view; and
a plurality of light steering optical elements that are movable to align different light steering optical elements with (1) an optical path of the of the emitted optical signals at different times and/or (2) an optical path of the optical returns to the optical sensor at different times, wherein each light steering optical element corresponds to a zone within the field of view; and
wherein each aligned light steering optical element provides (1) steering of the emitted optical signals incident thereon into its corresponding zone and/or (2) steering of the optical returns from its corresponding zone to the optical sensor so that movement of the light steering optical elements causes the lidar system to step through the zones on a zone-by-zone basis according to which of the light steering optical elements becomes aligned with the optical path of the emitted optical signals and/or the optical path of the optical returns over time.

2. The system of claim 1 wherein the movement comprises rotation, and wherein each zone corresponds to multiple angular positions of a rotator or carrier on which the light steering optical elements are mounted.

3. The system of claim 1 wherein the zone-by-zone basis comprises discrete stepwise changes in which of the zones is used for illumination and/or acquisition in response to continuous movement of the light steering optical elements.

4. The system of claim 1 wherein the light steering optical elements comprise diffractive optical elements (DOEs).

5. The system of claim 4 wherein the DOEs comprise metasurfaces.

6. The system of claim 5 wherein the metasurfaces exhibit light steering properties that are defined according to phase delay functions, wherein each metasurface has a corresponding phase delay function that causes the metasurface to steer light to and/or from its corresponding zone.

7. The system of claim 5 wherein the metasurfaces comprise a plurality of nanostructures imprinted on an optically transparent substrate in a pattern that causes the aligned metasurfaces to steer light to and/or from its corresponding zone.

8. The system of claim 1 wherein the light steering optical elements comprise transmissive light steering optical elements.

9. The system of claim 1 wherein the movement of the light steering optical elements comprises rotation, the lidar system further comprising:
a rotator for rotating the light steering optical elements about an axis; and
a circuit that drives rotation of the rotator to align different light steering optical elements with the optical path of the emitted optical signals and/or the optical path of the optical returns over time.

10. The system of claim 9 wherein each light steering optical element aligns with (1) the optical path of the emitted optical signals and/or (2) the optical path of the optical returns to the optical sensor over an angular extent of an arc during the rotation of the light steering optical elements about the axis.

11. The system of claim 1 wherein the light steering optical elements comprise emitter light steering optical elements that provide steering of the emitted optical signals incident thereon into their corresponding zones in response to alignment with the optical path of the of the emitted optical signals.

12. The system of claim 1 wherein the light steering optical elements comprise receiver light steering optical elements that provide steering of the optical returns from their corresponding zones to the optical sensor in response to alignment with the optical path of the optical returns to the optical sensor.

13. The system of claim 1 wherein the light steering optical elements comprise emitter light steering optical elements and receiver light steering optical elements;
wherein the emitter light steering optical elements provide steering of the emitted optical signals incident thereon into their corresponding zones in response to alignment with the optical path of the of the emitted optical signals; and
wherein the receiver light steering optical elements provide steering of the optical returns from their corresponding zones to the optical sensor in response to alignment with the optical path of the optical returns to the optical sensor.

14. The system of claim 13 further comprising a carrier on which the emitter light steering optical elements and the receiver light steering optical elements are commonly mounted.

15. The system of claim 13 wherein the movement of the light steering optical elements comprises rotation, and wherein the emitter light steering optical elements and the receiver light steering optical elements are arranged in a concentric relationship with each other.

16. The system of claim 1 wherein the lidar system is a flash lidar system.

17. The system of claim 1 wherein the lidar system is a point illumination scanning lidar system, the system further comprising a scanning lidar transmitter that scans a plurality of the optical signals toward points in the field of view over time within each zone.

18. The system of claim 1 wherein the optical emitter comprises an array of optical emitters, the system further comprising a driver circuit for the emitter array, wherein the driver circuit independently controls how a plurality of the different emitters in the emitter array are driven to adaptively illuminate different regions in the zones with different optical power levels based on data derived from one or more objects in the field of view.

19. The system of claim 1 wherein the optical sensor comprises a photodetector array, the system further comprising a receiver barrel, the receiver barrel comprising:
the photodetector array;
a collection lens that collects incident light from aligned light steering optical elements;
a spectral filter that filters the collected incident light; and
a focusing lens that focuses the collected incident light on the photodetector array.

20. A method for operating a lidar system, the method comprising:
emitting optical signals into a field of view, wherein the field of view comprises a plurality of zones;
optically sensing returns of a plurality of the emitted optical signals from the field of view; and
moving a plurality of light steering optical elements to align different light steering optical elements with (1) an optical path of the of the emitted optical signals at different times and/or (2) an optical path of the returns for the optical sensing at different times, wherein each light steering optical element corresponds to a zone within the field of view; and
wherein each aligned light steering optical element provides (1) steering of the emitted optical signals incident thereon into its corresponding zone and/or (2) steering of the optical returns from its corresponding zone to the optical sensor so that the moving causes the lidar system to step through the zones on a zone-by-zone basis according to which of the light steering optical elements becomes aligned with the optical path of the emitted optical signals and/or the optical path of the returns over time.
